(19) United States
(12) Patent Application Publication
(10) Pub. No.: US 2024/0210731 A1
(43) Pub. Date: Jun. 27, 2024

(54) ENHANCED-SUMMATION CONTACT LENS PAIR FOR CORRECTION OF PRESBYOPIA, AND RELATED LENSES PAIR SYSTEMS AND FITTING METHODS

(71) Applicant: Johnson & Johnson Vision Care, Inc., Jacksonville, FL (US)

(72) Inventors: Minghan Chen, Jacksonville, FL (US); Gregory A. Williby, Jacksonville, FL (US); Khaled Chehab, Jacksonville, FL (US)

(21) Appl. No.: 18/387,254

(22) Filed: Nov. 6, 2023

Related U.S. Application Data
(60) Provisional application No. 63/434,401, filed on Dec. 21, 2022.

(51) Int. Cl. G02C 7/04

(52) U.S. Cl. CPC G02C 7/044; G02C 7/047

(57) ABSTRACT

Enhanced-summation contact lens pair for correction of presbyopia, and related enhanced-summation contact lens pairs systems and fitting methods. The optical zones of the enhanced-summation contact lens pairs are optimized as a binocular system such that a lens wearer experiences enhanced presbyopia-corrected near-distance vision like that of near monovision, but also with enhanced intermediate-distance and far-distance vision. Enhanced presbyopia-corrected near-distance vision is achieved through a center-near optical zone of the center-near non-dominant eye lens, have an add power and being optimized in diameter size based anticipated pupil miosis. Enhanced intermediate-distance vision by transitional optical zones in the enhanced-summation contact lens pair emulating an extended depth-of-focus (EDOF) through binocular summation and multi-focality when the wearer is focused on intermediate-distance objects. Enhanced far-distance vision is achieved by light received through the enhanced-summation contact lens pair when the wearer is focused on far-distance objects, emulating what is called “partial monovision.”

### PRIORITY APPLICATION

This application claims the benefit of U.S. Provisional Patent Application Ser. No. 63/434,401, filed on Dec. 21, 2022, entitled, “ENHANCED-SUMMATION CONTACT LENS PAIR FOR CORRECTION OF PRESBYOPIA, AND RELATED LENSES PAIR SYSTEMS AND FITTING METHODS,” the disclosure of which is hereby incorporated herein by reference in its entirety.

### FIELD OF THE DISCLOSURE

The field of the disclosure relates to ophthalmic lenses useful for the correction of presbyopia.

### BACKGROUND

As an individual ages, the eye is less able to accommodate or bend the natural crystalline lens of the eye to focus on objects that are relatively near to the observer. This condition is known as presbyopia. Presbyopia is the gradual loss of the eye's ability to focus on nearby objects. Similarly, for persons who have had their natural lens crystalline removed (e.g., as a result of cataract surgery), and an intraocular lens inserted as a replacement lens, the ability to accommodate is absent. Presbyopia usually becomes noticeable in one's age of early to mid-40s and continues to worsen until around age 65.

One method to correct for the eye's failure to accommodate is to employ a monovision lens strategy. In monovision, a first single-vision lens is employed for the correction of distance vision for the lens wearer's dominant eye. A second single-vision lens is then employed for correction of near-distance vision for the lens wearer's non-dominant eye. This is shown by example in FIGS. 1A and 1B. FIG. 1A is a diagram illustrating monovision at a focal point of a near-distance object 100 (such as a book) greater than 2.5 diopters from a corrective lens pair 102 of a first single vision lens 104 (“first lens 104”) for correction of near-distance vision for the lens wearer's non-dominant eye and a second single vision lens 106 (“second lens 106”) for correction of far-distance vision for the lens wearer's dominant eye. In this example, the first lens 104 also has an add power of +1.75 diopters relative to distance correction for correction of presbyopia. FIG. 1B is a diagram illustrating monovision at a focal point of a far-distance object 108 less than 0.25 diopters from the corrective lens pair 102. As shown in FIGS. 1A and 1B, the first lens 104 has a first power profile that is optimized for improved vision at near distances. The second lens 106 has a second aspheric power profile that is optimized for improved vision at far distances. The aspheric power profile of the first lens 104 has an added paraxial power that is offset in diopter from the paraxial power in the second aspheric power profile of the second lens 106. This provides add power in the first lens 104 over the second lens 106 to provide a presbyopia correction in the first lens 104.

In this manner, as shown in FIG. 1A, when an individual wearing the first and second lenses 104, 106 focuses at a near-distance object, improved vision is achieved through the first lens 104 and its add power. However, as shown in FIG. 1B, when an individual wearing the first and second lenses 104, 106 focuses at a far-distance object, improved vision is achieved through the second lens 106 that does not include the add power. Advantages of a monovision lens pair strategy include good vision and contrast at both far-distance and near-distance objects. Lens costs are reduced because single-vision lenses are used for each lens in the monovision lens pair. Lens fitting is also less complicated. However, a monovision lens pair strategy is disadvantageous because it results in a loss of stereopsis due to the disparity between add power in the lenses for presbyopia. Monovision may also have lower intermediate-distance vision performance because each lens 104, 106 in the corrective lens pair 102 is designed to achieve superior near-distance and far-distance vision, respectively.

Another known method for correction of presbyopia is to use a bifocal or multifocal lens in a patient wearer's eyes. A multi-focal lens is designed to have particular surface designs to achieve multiple optical focal distances. Some multifocal lenses are designed to have an extended depth of focus that “spreads” the focus along a wider range as a single elongated focal point to enhance range of vision or depth-of-focus instead of multiple optical focal distances. In this regard, FIG. 2 is a diagram that shows how light received through a multi-focal lens 200 that is designed to have an extended depth-of-focus (EDOF), focuses that received light over a wider range, elongated focal point 202. As shown in FIG. 2, light 204 received by the multi-focal lens 200 is refracted and focused on a focal length depending on the received radial location in the multi-focal lens 200. For example, the multi-focal lens 200 may have an aspheric power profile. The power profile of the multi-focal lens 200 is such that the received light 204 is focused over the elongated focal point 202. Advantages of a multi-focal lens strategy include reduced disparity in corrective power between the lenses in the multi-focal contact lens pair. Multi-focal lenses may also have higher intermediate-distance vision performance, because these lenses may have an EDOF with a peak performance for intermediate-distance focused objects. However, multifocal lens designs typically tradeoff performance among far-distance, intermediate-distance, and near-distance vision. Thus, use of bifocal or multifocal lenses in both eyes could result in a reduction visual acuity (i.e., image resolution) and image contrast at near-distance vision as compared to a monovision lens strategy.

Yet another method of treating presbyopia is to place a bifocal or multifocal lens in one eye and a single-vision lens in the other eye. The disadvantage in using this method is in the large number of lenses that must be considered in order to provide the individual with satisfactory vision.

### SUMMARY OF THE DISCLOSURE

Aspects disclosed herein include an enhanced-summation contact lens pair for correction of presbyopia. Related enhanced-summation contact lens pairs systems and fitting methods are also disclosed. The enhanced-summation contact lens pair includes a center-far lens fitted to a patient wearer's (“wearer's”) dominant eye and center-near lens fitted to the wearer's non-dominant eye. A dominant eye is the eye that provides more signal input to the visual cortex of an individual's brain, whereas a non-dominant eye is the other eye that provides less signal input to the visual cortex of an individual's brain. The center-far lens and the center-near lens are fitted to the dominant and non-dominant eyes of a wearer, respectively, based on a refractive correction for far-distance vision. The optical zones of the enhanced-summation contact lens pairs are optimized and fitted to a wearer as a binocular system such that the wearer experiences enhanced presbyopia-corrected near-distance vision like that of near-distance monovision but also with enhanced intermediate-distance and partial monovision far-distance vision through multi-focal effects from the lens pairs.

Enhanced presbyopia-corrected, near-distance vision is achieved through the large monocular visual acuity (VA) disparity at near-distance vision (such as ˜2.5 diopters) between a wearer's dominant and non-dominant eyes, wearing the respective dominant eye, center-far lens and non-dominant eye, center-near lens. In the non-dominant eye center-near lens, a center-near optical zone of the center-near non-dominant eye lens has a refractive correction power (if needed), and an add power for presbyopia correction. The center-near optical zone is also optimized in optical zone diameter size based on studies of constricted pupil size when a wearer focuses at a near-distance object due to pupil miosis. This optimized diameter of the center-near optical zone provides for an increased percentage of light to be received in the non-dominant eye pupil through the center-near optical zone when the wearer focuses on near-distance objects. Thus, a higher monocular VA can be achieved in the non-dominant eye wearing the non-dominant eye center-near lens. On the other hand, the dominant eye, center-far lens, has a center-far optical zone with a refractive correction based on far distance vision. The center-far optical zone has optical zone diameter size that may be smaller than the center-near optical zone of the non-dominant center-near lens. Thus also, when the wearer focuses at a near-distance object due to pupil miosis, the dominant eye pupil is only covered by the center-far optical zone of the dominant eye, center-far lens. Thus, a lower monocular VA is achieved in the dominant eye wearing the center-far lens than is achieved in the non-dominant eye wearing the center-near lens. This results in a larger monocular VA difference between the dominant and non-dominant eyes, which causes the enhanced-summation lens pair to operate as a monovision lens pair for enhanced presbyopia-corrected, near-distance vision. The individual's brain will process the focused image of higher VA from light predominantly received in the individual's non-dominant eye through the center-near optical zone over significantly reduced VA images from light received in individual's dominant eye through the center-far optical zone of the center-far dominant eye lens.

Enhanced intermediate-distance vision is achieved by binocular summation of light received through transitional optical zones in the enhanced-summation contact lens pair when a wearer is focused on intermediate-distance objects. This emulates an extended depth-of-focus (EDOF) through binocular summation and multi-focality. At intermediate-distance vision (e.g., ˜1.6 diopters), both a wearer's dominant eye wearing the dominant eye, center-far lens and non-dominant eye wearing the non-dominant, center-near lens employ the EDOF effects from the transitional optical zones of the lenses to achieve a minimized monocular VA disparity than is then summed by the wearer's brain to provide enhanced intermediate-distance vision.

Enhanced far-distance vision is achieved by light received through the enhanced-summation contact lens pair when the wearer is focused on far-distance objects, emulating what is called “partial monovision.” At far-distance vision, the patient's pupils dilate to a larger diameter size with a longer depth of focus in both the dominant and non-dominant eye. The light received by the wearer's dominant and non-dominant eye while wearing the respective center-far and center-near lens pair contributes to far-distance vision. Only a “weak” summation occurs for far-distance vision since the dominant eye (wearing the dominant eye, center-far lens) contributes more to far-distance vision than that of non-dominant eye (wearing the non-dominant eye, center-near lens). This is defined as “partial monovision.” Thus, the non-dominant eye has a worse monocular image quality than that of the dominant eye. Thus, “partial monovision” is defined as a weak binocular summation of (1) far-distance vision through a center-far optical zone in the dominant eye wearing the dominant-eye, center-far-lens, and (2) a weak multi-focality of light received through the transitional optical zones of the enhanced-summation contact lens with the non-dominant eye, center-near lens providing an EDOF for far-distance vision. Because the transitional optical zones of the enhanced-summation contact lens pair are optimized for intermediate-distance vision, there will be more disparity in VA of light received through the enhanced-summation contact lens pair in far-distance vision than intermediate-distance vision. Since at far-distance vision, the dominant eye wearing the dominant eye, center-far lens will provide more vision correction than that of the weak EDOF effects offered by non-dominant eye wearing the non-dominant eye, center-near lens. This also means that dominant eye have less depth-of-focus (DOF) than that of the non-dominant eye.

In this regard, in an exemplary aspect, an enhanced-summation contact lens pair is provided. The enhanced-summation contact lens pair comprises a center-far lens for a dominant eye of a contact lens wearer. The center-far lens comprises a center-far optical zone of a center-far zone diameter disposed around a first optical axis and having a first power, and a first transitional optical zone surrounding the first center optical zone, the first transitional optical zone having a first progressive power profile. The enhanced-summation contact lens pair also comprises a center-near lens for a non-dominant eye of a contact lens wearer. The center-near lens comprises a center-near optical zone of a center-near zone diameter surrounding a second optical axis and having a second power, an add power of at least +0.75 diopters relative to the first power, and a second transitional optical zone surrounding the second center optical zone, the second transitional optical zone having a second progressive power profile. The center-far zone diameter and the center-near zone diameter are selected such that when the contact lens wearer is focusing on a near-distance object, a contact lens pair comprising the center-far lens and the center-near lens emulates monovision, and when the contact lens wearer is focusing on a far-distance object, the contact lens pair emulates partial monovision. Further, the first transitional optical zone and the second transitional optical zone are selected such that when the contact lens wearer is focusing on an intermediate-distance object, the contact lens pair emulates an EDOF lens through binocular summation.

In another exemplary aspect, an enhanced-summation contact lens pair is provided. The enhanced-summation contact lens pair comprises a center-far lens for a dominant eye of a contact lens wearer. The center-far lens comprises a center-far optical zone of a center-far zone diameter disposed around a first optical axis and having a first power, and a first transitional optical zone surrounding the first center optical zone, the first transitional optical zone having a first progressive power profile. The enhanced-summation contact lens pair also comprises a center-near lens for a non-dominant eye of a contact lens wearer. The center-near lens comprises a center-near optical zone of a center-near zone diameter targeted to an average pupil size of a population and surrounding a second optical axis and having a second power, an add power relative to the first power, and a second transitional optical zone surrounding the second center optical zone, the second transitional optical zone having a second progressive power profile.

The power profiles of the dominant eye, center-far and non-dominant eye, center-near lenses can be customized based on design parameters, including pupil miosis data and expected spherical aberration that naturally occurs in an individual's ocular system when focusing on objects at different distances. For example, the diameter of the center-near optical zone of the center-near non-dominant eye lens can be between 2.6 millimeters (mm) and 4.0 mm. The diameter of the center-far optical zone of the center-far dominant eye lens can be between 1.8 mm and 3.8 mm. The power profiles of the dominant eye, center-far and non-dominant eye, center-near lenses are also designed based on a desired correction prescription for a given stock keeping unit (SKU) of the lenses as well as the add power desired for the center-near optical zone of the center-near non-dominant eye lens for correction of presbyopia.

Enhanced-summation contact lens pair systems can also be provided that include a plurality of center-near non-dominant eye lenses and center-far dominant eye lenses to provide an optimal vision for an individual. The enhanced-summation contact lens pair systems can include the center-near non-dominant eye lenses and center-far dominant eye lenses that includes lenses having a correction prescription power covers powers from −12.0 diopters to +9.0 diopters, as an example. The enhanced-summation contact lens pair systems can also include center-near non-dominant eye lenses that include effective add powers over the add power range of +0.75 diopters to +2.5 diopters as another example to made lenses available with different add powers for the range of correction powers. For example, the enhanced-summation contact lens pair system may include center-near non-dominant eye lenses over the range of provided correction powers that include three (3) add power profiles that include power profiles of or substantially of: (1) a non-dominant low-add power profile comprising the center-near zone diameter of 4.0 mm, the second transitional optical zone having a second transitional diameter between 4.0 mm to 6.0 mm, and the add power between +0.9 and +1.1 diopters; (2) a non-dominant mid-add power profile comprising the center-near diameter of 4.0 mm, the second transitional optical zone having a second transitional diameter between 4.0 mm to 6.0 mm, and the add power between +0.9 and +1.2 diopters; and (3) a non-dominant high-add power profile comprising the center-near diameter of 4.0 mm, the second transitional optical zone having a second transitional diameter between +4.0 mm to +6.0 mm, and the add power between +1.0 and 1.2 diopters. Above a 6.0 mm diameter, for each of the non-dominant low-add, mid-add, and high-add power profiles of the center-near dominant eye lenses, the lens power profiles in this example are designed to correct patient's far-distance refractive error, population averaged ocular spherical aberration and offer an improved/optimized visual acuity performance with a larger pupil size (covering center and peripheral zones).

The enhanced-summation contact lens pair system may also include center-far dominant eye lenses over the range of provided correction powers that include three (3) add power profiles that include power profiles of or substantially of: (1) a dominant low-add power profile comprising a center-far zone diameter between 2.0 and 2.8 mm, wherein the first transitional optical zone has a first transitional diameter greater than the center-far optical zone radius and a dominant add power between 0.1 and 0.4 diopters; (2) a dominant mid-add power profile comprising a center-far zone diameter between 2.4 and 3.8 mm, wherein the first transitional optical zone having a first transitional diameter greater than the center-far zone diameter, and a dominant add power between 0.1 and 0.4 diopters, and (3) a dominant high-add power profile comprising a center-far zone diameter between 1.8 and 2.2 mm, wherein the first transitional optical zone has a first transitional radius greater than the center-far zone diameter, and a dominant add power between 0.1 and 0.4 diopters. Above the center portion of transition zone (which may be between 1-2.2 mm diameter regions), for each of the low-add, mid-add, and high-add power profiles of the center-far dominant eye lenses, the lens power profiles in this example are designed to correct patient's far-distance refractive error, population averaged ocular spherical aberration and offer an improved/optimized visual acuity performance with a larger pupil size (covering center and peripheral zones).

Other exemplary aspects can also include an enhanced-summation contact lens pair system. The enhanced-summation contact lens pair system includes a plurality of center-far lenses for a dominant eye of a contact lens wearer and a plurality of center-near lenses for a non-dominant eye of a contact lens wearer. Each of the plurality of center-far lenses can include a correction power over a range of available refractive correction powers for correction of hyperopia or myopia. Each of the plurality of center-near lenses can include a refractive correction power over a range of available refractive correction powers for correction of hyperopia or myopia and an add power for correction of presbyopia. Each of the plurality of center-far lenses and the plurality of center-near lenses can include any of the references center-far and center-near lenses disclosed herein.

Other exemplary aspects can also include a method of fitting an enhanced-summation contact lens pair of the enhanced-summation contact lens pair system as described above and in the detailed description to a contact lens wearer. The method can include: a) selecting an add power for the contact lens wearer. The method can then include: b) selecting a next enhanced-summation contact lens pair for the contact lens wearer, wherein a center-near lens of the plurality of center-near lenses having a second power based on the refractive correction for the contact lens wearers non-dominant eye and having the add power of the presbyopia correction for the contact lens wearer, and wherein a center-far lens of the plurality of center-far lenses having a first power based on the refractive correction for the contact lens wearer's dominant eye. For example, the refractive corrections for the contact lenses may be determined on the patient's need for refractive correction when focusing on a far-distance object at 0.25 diopters. The method can then next include: (c) receiving feedback from the contact lens wearer based on a perceived stereopsis based on the far-distance vision acuity difference between the contact lens wearer's dominant eye and non-dominant eye when focusing on a far-distance object. The method can then next include: d) in response to the feedback indicating a reduced stereopsis based on the far-distance vision acuity difference for the next enhanced-summation contact lens pair, perform at least one of selecting a next center-far lens of the plurality of center-far lenses for the contact lens wearer having an increase in the next first power; and selecting a next center-near lens of the plurality of center-near lenses for the contact lens wearer having a decrease in a next second power.

Additional features and advantages will be set forth in the detailed description which follows and, in part will be readily apparent to those skilled in the art from the description or recognized by practicing the aspects as described in the written description and claims hereof, as well as the appended drawings.

It is to be understood that both the foregoing general description and the following detailed description are merely exemplary and are intended to provide an overview or framework to understand the nature and character of the claims.

The accompanying drawings are included to provide a further understanding and are incorporated in and constitute a part of this specification. The drawings illustrate one or more aspects and, together with the description, serve to explain principles and operation of the various aspects.

### BRIEF DESCRIPTION OF THE FIGURES

The foregoing and other features and advantages of the disclosure will be apparent from the following, more particular descriptions of the aspects of the disclosure, as illustrated in the accompanying drawings.

FIGS. 1A and 1B are diagrams illustrating monovision provided by a mono-focal lens pair for near-distance and far-distance focused objects;

FIG. 2 is a diagram of an enhanced-summation lens that has an aspheric power profile that provides multifocality over different radial distances to provide an extended depth-of-focus (EDOF);

FIG. 3 is a schematic diagram of an exemplary enhanced-summation contact lens pair that includes a respective center-near non-dominant eye lens and a center-far dominant eye lens with optical zones optimized as a binocular system to provide superior presbyopia-corrected near-distance vision like that of monovision, but also with enhanced intermediate-distance and far-distance vision through binocular summation and multifocality;

FIG. 4A is a schematic diagram of an exemplary center-far dominant eye and center-near non-dominant eye contact lenses as worn by a contact lens wearer illustrating the relative diameter of the center-far and center-near optical zones, and transitional optical zone(s) of the contact lenses, as compared to the constricted pupil of the contact lens wearer when focusing on a near-distance object;

FIG. 4B is a schematic diagram of an exemplary center-far dominant eye and center-near non-dominant eye contact lenses as worn by a contact lens wearer illustrating the relative diameter of the center-far and center-near optical zones and transitional optical zone(s) of the contact lenses, as compared to the dilated pupil of the contact lens wearer when focusing on a far-distance object;

FIG. 5 is a diagram illustrating exemplary improved clarity and contrast of far-distance, intermediate-distance, and near-distance vision by a contact lens wearer of the dominant eye, center-far and non-dominant eye, center-near lenses like in FIG. 3;

FIG. 6A is a diagram illustrating enhanced presbyopia-corrected near-distance monovision that can be provided by a dominant eye, center-fair and a non-dominant eye, center-near lenses like in FIG. 3 when a contact lens wearer of such lenses focuses on a near-distance object;

FIG. 6B is a diagram illustrating partial monovision for far-distance vision by a contact lens wearer of the dominant eye, center-far and non-dominant eye, center-near lenses like in FIG. 3 when the contact lens wearer focuses on a far-distance object;

FIG. 6C is a diagram illustrating enhanced intermediate-distance vision by a contact lens wearer of a center-far dominant eye and a center-near non-dominant eye lens like in FIG. 3, through binocular summation and multi-focality when the contact lens wearer focuses on an intermediate-distance object;

FIG. 7 is a diagram illustrating conventional multi-focality of higher clarity and contrast intermediate-distance vision, as compared to lower clarity and contrast far-distance and near-distance vision, by a contact lens wearer of conventional center-near enhanced-summation contact lenses;

FIG. 8 is a diagram illustrating conventional monovision of higher clarity and contrast far-distance and near-distance vision, as compared to lower clarity and contrast intermediate-distance vision, by a contact lens wearer of conventional center-near enhanced-summation contact lenses;

FIG. 9 is a schematic diagram of the center-far dominant eye lens and center-near non-dominant eye lens in FIG. 3;

FIG. 10A is a graph illustrating an exemplary power profile as function of radius of the center-far dominant eye lens like in FIG. 9;

FIG. 10B is a graph illustrating an exemplary power profile as function of radius of the center-near non-dominant eye lens like in FIG. 9B, and illustrating its center-near optical zone having a paraxial add power relative to the first power in the center-far optical zone of the center-far dominant eye lens like in FIG. 9;

FIG. 11 is a graph illustrating an exemplary visual acuity performance as a function of vergence of far-distance, intermediate-distance, and near-distance vision with the dominant eye, center-far and non-dominant eye, center-near lenses like in FIG. 3, as compared to conventional center-near enhanced-summation lenses;

FIG. 12 is a diagram illustrating exemplary mean pupil diameter size as well as standard deviation and variation of pupil diameter based on a pupil size study of myope and hyperope subjects in photopic and mesopic conditions;

FIG. 13A is a graph illustrating an exemplary dynamic pupil miosis model that models average pupil diameter as a function of paraxial accommodation power;

FIG. 13B is a graph illustrating an exemplary visual acuity (VA) as a function of vergence based on the dynamic pupil miosis model in FIG. 13A;

FIG. 14 illustrates a chart of exemplary actual add power to a center-near optical zone of a center-near non-dominant eye lens, like in FIG. 3B, to correct for presbyopia in monovision;

FIGS. 15A-15C are power profiles of exemplary respective low-add, mid-add, and high-add power profiles as a function of lens radius/diameter for a center-near non-dominant eye lens like in FIG. 3B across a range of refractive correction powers to illustrate center-near power profiles with paraxial low-add, mid-add, and high-add power in the center-near optical zone and, the power profile of the transitional zone(s);

FIGS. 15D-15F are power profiles of exemplary respective low-add, mid-add, and high-add power, power profiles as a function of lens radius/diameter for a center-far dominant eye lens like in FIG. 3 across a range of refractive correction powers;

FIG. 16 is a chart illustrating improved binocular VA to a contact lens wearer wearing the dominant eye, center-far and non-dominant eye, center-near lenses like in FIG. 3, having the low-add power profiles in FIGS. 15A and 15D for an effective low-add power of 1.25 diopters and a refractive correction of −3.0 diopters, for a variety of different diameter center-near optical zones in the center-near non-dominant eye lens and center-far optical zones in the center-far dominant eye lens at 5.4, 4 and 3 millimeters (mm) pupil sizes (EPD);

FIGS. 17A-17C are graphs illustrating exemplary binocular VAs as a function of vergence between an individual at near-distance, intermediate-distance, and far-distance vision wearing for a pair of enhanced-summation contact lenses described herein as compared to wearing Acuvue® presbyopia lens with a pupil of 4, 5.4 and 3 mm;

FIG. 18 is a chart illustrating improved binocular VA to a contact lens wearer wearing the dominant eye, center-far and non-dominant eye, center-near lenses like in FIGS. 3 having the mid-add power profiles in FIGS. 15B and 15E for an effective mid-add power of 1.5 diopters and a prescriptive correction of −3.0 diopters, for a variety of different diameter center-near optical zones in the center-near non-dominant eye lens and center-far optical zones in the center-far dominant eye lens at 5.4, 4 and 3 mm pupil sizes (EPD);

FIGS. 19A-19C are graphs illustrating exemplary binocular VAs as a function of vergence and for a pair enhanced-summation contact lenses described herein as compared to wearing Acuvue® presbyopia lenses with a pupil of 4, 5.4, and 3 mm;

FIG. 20 is a chart illustrating improved binocular VA to a contact lens wearer wearing the dominant eye, center-far and non-dominant eye, center-near lenses like in FIG. 3, having the high-add power profiles in FIGS. 15C and 15F for an effective high-add power of 2.0 diopters and a prescriptive correction of −6.0 diopters, for a variety of different diameter center-near optical zones in the center-near non-dominant eye lens and center-far optical zones in the center-far dominant eye lens at 5.4, 4 and 3 mm pupil sizes (EPD);

FIGS. 21A-21C are graphs illustrating exemplary binocular VAs as a function of vergence and for a pair of enhanced-summation contact lenses described herein as compared to wearing Acuvue® presbyopia lenses with a pupil of 4, 5.4, and 3 mm;

FIG. 22A is a graph illustrating an exemplary monocular VA as a function of vergence with large disparity at near-distance and far-distance vision for enhanced-summation contact lenses like in FIG. 3 for both dominant and non-dominant eyes;

FIG. 22B is a graph illustrating an exemplary monocular VA as a function of vergence with reduced disparity at far-distance vision for the enhanced-summation contact lenses like in FIG. 3 for both dominant and non-dominant eyes;

FIGS. 23A-23F are graphs illustrating exemplary monocular VAs as a function of vergence for a fitting guide for a contact lens wearer wearing dominant eye, center-far and non-dominant eye, center-near lenses like for both dominant eye and non-dominant eye in FIG. 3, illustrating reduced disparity, which is the VA difference at far distance, in VA as a function of incrementally varying refractive power in the respective center-far dominant eye lens and the center-near non-dominant eye lens; and

FIG. 24 is a flowchart illustrating an exemplary process of fitting an enhanced-summation contact lens pair of an enhanced-summation contact lens pair system to a contact lens wearer, wherein the enhanced-summation contact lens pair includes a plurality of center-far dominant and center-near non-dominant contact lenses like in FIG. 3 or as otherwise described in any other aspects for different corrective prescriptions and effective add powers, to arrive at an optimized selection of center-far dominant and center-near non-dominant eye lens for the contact wearer with improved VA and near-distance, intermediate-distance, and far-distance visions.

### DETAILED DESCRIPTION

Aspects disclosed herein include an enhanced-summation contact lens pair for correction of presbyopia. Related enhanced-summation contact lens pairs systems and fitting methods are also disclosed. The enhanced-summation contact lens pair includes a center-far lens fitted to a patient wearer's (“wearer's”) dominant eye and center-near lens fitted to the wearer's non-dominant eye. A dominant eye is the eye that provides more signal input to the visual cortex of an individual's brain, whereas a non-dominant eye is the other eye that provides less signal input to the visual cortex of an individual's brain. The center-far lens and the center-near lens are fitted to the dominant and non-dominant eyes of a wearer, respectively, based on a refractive correction for far-distance vision. The optical zones of the enhanced-summation contact lens pairs are optimized and fitted to a wearer as a binocular system such that the wearer experiences enhanced presbyopia-corrected near-distance vision like that of near-distance monovision but also with enhanced intermediate-distance and partial monovision far-distance vision through multi-focal effects from the lens pairs.

Enhanced presbyopia-corrected, near-distance vision is achieved through the large monocular visual acuity (VA) disparity at near-distance vision (such as ˜2.5 diopters) between a wearer's dominant and non-dominant eyes, wearing the respective dominant eye, center-far lens and non-dominant eye, center-near lens. In the non-dominant eye center-near lens, a center-near optical zone of the center-near non-dominant eye lens has a refractive correction power (if needed), and an add power for presbyopia correction. The center-near optical zone is also optimized in optical zone diameter size based on studies of constricted pupil size when a wearer focuses at a near-distance object due to pupil miosis. This optimized diameter of the center-near optical zone provides for an increased percentage of light to be received in the non-dominant eye pupil through the center-near optical zone when the wearer focuses on near-distance objects. Thus, a higher monocular VA can be achieved in the non-dominant eye wearing the non-dominant eye center-near lens. On the other hand, the dominant eye, center-far lens, has a center-far optical zone with a refractive correction based on far-distance vision. The center-far optical zone has optical zone diameter size that may be smaller than the center-near optical zone of the non-dominant center-near lens. Thus also, when the wearer focuses at a near-distance object due to pupil miosis, the dominant eye pupil is only covered by the center-far optical zone of the dominant eye, center-far lens. Thus, a lower monocular VA is achieved in the dominant eye wearing the center-far lens than is achieved in the non-dominant eye wearing the center-near lens. This results in a larger monocular VA difference between the dominant and non-dominant eyes, which causes the enhanced-summation contact lens pair to operate as a monovision lens pair for enhanced presbyopia-corrected, near-distance vision.

Enhanced intermediate-distance vision is achieved by binocular summation of light received through transitional optical zones in the enhanced-summation contact lens pair when a wearer is focused on intermediate-distance objects. This emulates an extended depth-of-focus (EDOF) through binocular summation and multi-focality. At intermediate-distance vision (e.g., ˜1.6 diopters), both a wearer's dominant eye wearing the dominant eye, center-far lens and non-dominant eye wearing the non-dominant, center-near lens employ the EDOF effects from the transitional optical zones of the lenses to achieve a minimized monocular VA disparity than is then summed by the wearer's brain to provide enhanced intermediate-distance vision.

Enhanced far-distance vision is achieved by light received through the enhanced-summation contact lens pair when the wearer is focused on far-distance objects, emulating what is called “partial monovision.” At far-distance vision, the patient's pupils dilate to a larger diameter size with a longer depth of focus in both the dominant and non-dominant eye. The light received by the wearer's dominant and non-dominant eye while wearing the respective center-far and center-near lens pair contribute to far-distance vision. Only a “weak” summation occurs for far-distance vision since the dominant eye (wearing the dominant eye, center-far lens) contributes more to far-distance vision than that of non-dominant eye (wearing the non-dominant eye, center-near lens). This is defined as “partial monovision.” Thus, the non-dominant eye has a worse monocular image quality than that of the dominant eye. Thus, “partial monovision” is defined as a weak binocular summation of (1) far-distance vision through a center-far optical zone in the dominant eye wearing the dominant-eye, center-far-lens, and (2) a weak multi-focality of light received through the transitional optical zones of the enhanced-summation contact lens pair with the non-dominant eye, center-near lens providing an EDOF for far-distance vision. Because the transitional optical zones of the enhanced-summation contact lens pair are optimized for intermediate-distance vision, there will be more disparity in VA of light received through the enhanced-summation contact lens pair in far-distance vision than intermediate-distance vision. Since at far-distance vision, the dominant eye wearing the dominant eye, center-far lens will provide more vision correction than that of the weak EDOF effects offered by non-dominant eye wearing the non-dominant eye, center-near lens. This also means that the dominant eye will have less depth-of-focus (DOF) than that of the non-dominant eye.

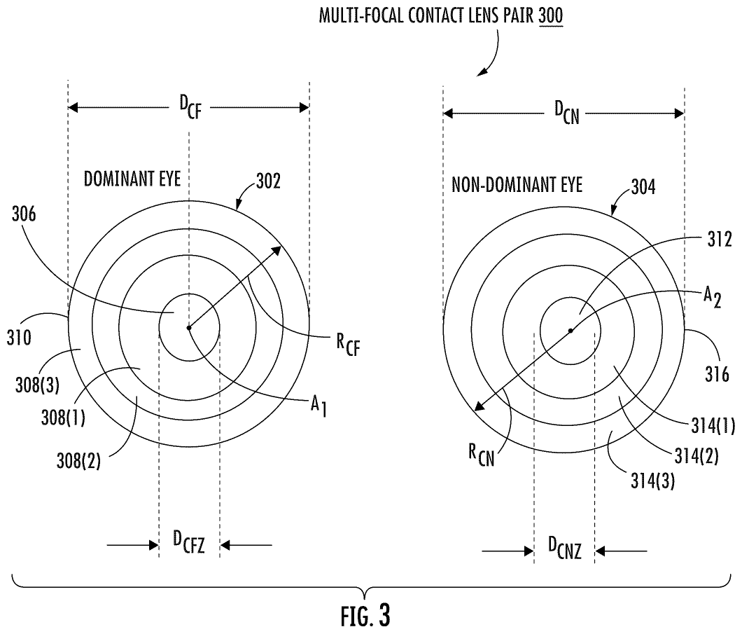

In this regard, FIG. 3 is a schematic diagram of an exemplary enhanced-summation contact lens pair 300 (also referred to as “contact lens pair 300”) for correction of presbyopia. The enhanced-summation contact lens pair 300 includes a center-far dominant eye contact lens 302 (also referred to as “center-far lens 302”) and center-near non-dominant eye contact lens 304 (also referred to as “center-near lens 304”) that can be worn by a contact lens wearers (“wearer's”) respective dominant and non-dominant eyes. The contact lenses 302, 304 provide multi-focality with corrected presbyopia for near-distance vision. The center-far dominant eye lens 302 is designed to be fitted to a wearer's dominant eye, whereas the center-near lens 304 is designed to be fitted to a wearer's non-dominant eye. A dominant eye is the eye that provides more signal input to the visual cortex of an individual's brain. A non-dominant eye is the other eye of the individual that provides less signal input to the visual cortex of the individual's brain. As discussed in more detail below, the optical zones of the enhanced-summation contact lens pair 300 are optimized and fitted to a wearer as a binocular system such that the wearer experiences enhanced presbyopia-corrected near-distance vision like that of monovision, but also with enhanced intermediate-distance vision through binocular summation and far-distance vision through partial monovision.

As shown in FIG. 3, in this example, the center-far lens 302 for a dominant eye of a contact lens wearer has a center-far optical zone 306 disposed around a first optical axis A₁. As discussed in more detail below, the center-far optical zone 306 has a center-far zone diameter D_{CFZ} that is optimized based on anticipated pupil dilation when a wearer is focused on a far-distance object (e.g., at 0.25 diopters) and an intermediate-distance object (e.g., at 1.6 diopters). The center-far optical zone 306 has a first power selected to correct for a refractive correction power for distance vision for a wearer's dominant eye according to their dominant eye prescription in this example. The center-far optical zone 306 may be spherical or have some target spherical aberration that is dependent on the corrective first power in the center-far optical zone 306. The center-far lens 302 also includes one or more transitional optical zones 308(1)-308(3) that each includes a respective refractive correction power profile for correction of light rays (“light”) passing through the center-far lens 302 are different radiuses R_{CF} outside of the center-far optical zone 306 relative to the first optical axis A₁ of the center-far lens 302. For example, each transitional optical zone 308(1)-308(3) may have a progressive power profile that provides an overall multi-focality to the wearer as a function of the distance of a focused object. In this example, the power profiles of the first and second transitional optical zones 308(1), 308(2) provide a non-continuous or derivative non-continuous change in power at their respective transitions to the respective second and third transitional optical zones 308(2), 308(3). Alternatively, the center-far lens 302 may have a single transitional optical zone that surrounds the center-far optical zone 306 and has a continuous power profile power. In this example, the first transitional optical zone 308(1) surrounds the center-far optical zone 306. The second transitional optical zone 308(2) surrounds the first transitional optical zone 308(1). The third transitional optical zone 308(3) surrounds the second transitional optical zone 308(2) and extends to the lens edge 310 of the center-far lens 302. The center-far lens 302 has an overall center-far diameter D_{CF} from the first optical axis A₁ to the lens edge 310.

As also shown in FIG. 3, in this example, the center-near lens 304 for a non-dominant eye of a contact lens wearer has a center-near optical zone 312 disposed around a second optical axis A₂. As discussed in more detail below, the center-near optical zone 312 has a center-near zone diameter D_{CNZ} that is optimized based on anticipated pupil constriction when a wearer is focused on a near-distance object (e.g., at 2.5 diopters). The center-near optical zone 312 has a second power selected to correct for a designed refractive correction power for far-distance vision of a wearer's non-dominant eye according to the prescription of the non-dominant eye in this example. The center-near optical zone 312 may be spherical or have some target spherical aberration that is dependent on the corrective power in the center-near optical zone 312. Also, in this example, the center-near optical zone 312 also has an effective add power that is added relative to its label power (e.g., at least +0.75 diopters of added power) to provide for correction of presbyopia in the wearer's non-dominant eye. Effective add power means an add power that is relative to a lens' labeled powered. The add power provides an effective add power for correction of presbyopia to the lens wearer. The center-near lens 304 also includes one or more transitional optical zones 314(1)-314(3) that each includes a respective correction power profile for focusing light through the center-near lens 304 at different radiuses R_{CN} outside of the center-near optical zone 312 and relative to the second optical axis A₂ of the center-near lens 304. For example, each transitional optical zone 314(1)-314(3) may have a continuous progressive power profile that provides an overall multi-focality as a function of distance to a focused object by the wearer. In this example, the power profiles of the first transitional optical zone has a derivative change in power at their respective transitions to the second transitional optical zone 314(2). A derivative change in power profile means that the power profile has a derivative that is not a continuous function. Alternatively, the center-near lens 304 may have a single transitional optical zone that surrounds the center-near optical zone 312 and has a continuous power profile power. In this example, the first transitional optical zone 314(1) surrounds the center-near optical zone 312. The second transitional optical zone 314(2) surrounds the first transitional optical zone 314(1). The third transitional optical zone 314(3) surrounds the second transitional optical zone 314(2) and extends to the lens edge 316 of the center-near lens 304. The center-near lens 304 has an overall center-near diameter D_{CN} from the second optical axis A₂ to the lens edge 316.

As discussed in more detail below, enhanced presbyopia-corrected, near-distance vision is achieved through the large monocular visual acuity (VA) disparity at near-distance vision (such as ˜2.5 diopters) between a wearer's dominant and non-dominant eyes, wearing the respective center-far and center-near lenses 302, 304. As discussed in more detail below, the center-near zone diameter D_{CNZ} of the center-near optical zone 312 of the center-near lens 304 is optimized for near-distance vision. The center-near zone diameter D_{CNZ} and its refractive correction power are designed such that when the contact lens wearer is focusing on a near-distance object (e.g., >=2.5 diopters), the enhanced-summation contact lens pair 300 emulates monovision in the wearer's non-dominant eye for enhanced presbyopia-corrected near-distance vision. The enhanced-summation contact lens pair 300 emulates monovision for the wearer at near-distance viewing because center-near zone diameter D_{CNZ} of the center-near optical zone 312 in the non-dominant eye is specifically designed to more closely match the diameter of the wearer's pupil when constricted during near-distance viewing when pupil miosis occurs. Enhanced presbyopia-corrected near-distance vision is achieved through the center-near optical zone 312 of the center-near non-dominant eye lens 304 have the add power, and its center-near zone diameter D_{CNZ} being optimized in size based on estimated diameter size of a constricted pupil when a wearer focuses at a near-distance object (e.g., at 2.5 diopters) due to pupil miosis. This optimized center-near zone diameter D_{CNZ} of the center-near optical zone 312 provides for an increased percentage of light to be received in the non-dominant eye pupil through the center-near optical zone 312 when the wearer focuses on near-distance objects. Thus, a higher monocular VA can be achieved in the non-dominant eye wearing the center-near lens 304.

On the other hand, the center-far zone diameter D_{CFZ} of the center-far optical zone 306 of the center-far lens 302 may be smaller than the center-near optical zone D_{CNZ} of the non-dominant center-near lens 304. Thus also, when the wearer focuses at a near-distance object, due to pupil miosis, the dominant eye pupil will only be covered by and receive light through the center-far optical zone 306 of the dominant eye, center-far lens 302. Thus, a lower monocular VA is achieved in the dominant eye wearing the center-far lens 302 than is achieved in the non-dominant eye wearing the center-near lens 304. This results in a larger monocular VA difference between the dominant and non-dominant eyes, which causes the enhanced-summation lens pair 300 to operate as a monovision lens pair for enhanced presbyopia-corrected, near-distance vision. The larger monocular VA difference between the dominant and non-dominant eyes will cause the wearer's brain and use image in the non-dominant eye.

Further, as also discussed in more detail below, the respective transitional optical zones 308(1)-308(3), 314(1)-314(3) of the center-far lens 302 and center-near lens 304 are selected such that when the contact lens wearer is focusing on an intermediate-distance object (e.g., between 1.0 and 2.0 diopters, e.g., at 1.6 diopters), the enhanced-summation contact lens pair 300 emulates an EDOF lens to provide an EDOF through binocular summation and multi-focality. An EDOF is the creation of a single elongated focal point, rather than several foci, to enhance depth of focus. Enhanced intermediate-distance vision is achieved through binocular summation and multi-focality of light received through the transitional optical zones 308(1)-308(3), 314(1)-314(3) of the respective contact lenses 302, 304 of the enhanced-summation contact lens pair 300 when a wearer is focused on intermediate-distance objects. At intermediate-distance vision, both a wearer's dominant eye wearing the dominant eye, center-far lens 302 and non-dominant eye wearing the non-dominant, center-near lens 304 employ the EDOF effects from the respective transitional optical zones 308(1)-308(3), 314(1), 314(3) of the lenses 302, 304 to achieve a minimized monocular VA disparity than is then summed by the wearer's brain to provide enhanced intermediate-distance vision.

Also, as discussed in more detail below, when the lens wearer is focusing on a far-distance object (e.g., <=0.25 diopters), the enhanced-summation contact lens pair 300 emulates what is called “partial monovision.” At far-distance vision, the patient's pupils dilate to a larger diameter size with a longer depth of focus in both the dominant and non-dominant eye. The light received by the wearer's dominant and non-dominant eye while wearing the respective center-far and center-near lenses 302, 304 contribute to far-distance vision. Only a “weak” summation occurs for far-distance vision since the dominant eye wearing the dominant eye, center-far lens 302, contributes more to far-distance vision than that of non-dominant eye wearing the non-dominant eye, center-near lens 304. This is defined as “partial monovision.” Thus, the non-dominant eye has a worse monocular image quality than that of the dominant eye. Thus, “partial monovision” is defined as a weak binocular summation of (1) far-distance vision through a center-far optical zone 306 in the dominant eye wearing the dominant-eye, center-far-lens 302, and (2) a weak multi-focality of light received through the transitional optical zones 308(1)-308(3), 314(1)-314(3) of the enhanced-summation contact lens pair 300 with the non-dominant eye, center-near lens 304 providing an EDOF for far-distance vision. Because the transitional optical zones 308(1)-308(3), 314(1)-314(3) of the enhanced-summation contact lens pair 300 are optimized for intermediate-distance vision, there will be more disparity in VA of light received through the enhanced-summation contact lens pair 300 in far-distance vision than intermediate-distance vision. Since at far-distance vision, the dominant eye wearing the dominant eye, center-far lens 302 will provide more vision correction than that of the weak EDOF effects offered by non-dominant eye wearing the non-dominant eye, center-near lens 304. This also means that dominant eye will have less depth-of-focus (DOF) than that of the non-dominant eye. However, the center-far center optical zone 306 of the center-far dominant eye lens 302 will contribute towards superior distance vision through far-distance monovision.

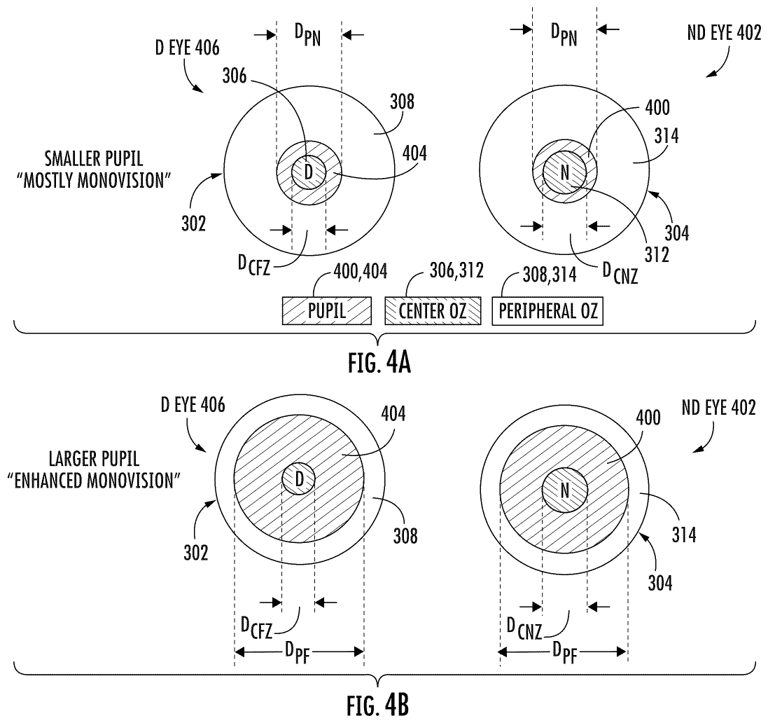

More exemplary discussion regarding the enhanced-summation contact lens pair 300 providing enhanced near-distance, intermediate-distance, and far-distance vision is now described below with continuing reference to FIG. 3 and with reference to FIGS. 4A-8.

In this regard, with continuing reference to FIG. 3, for the enhanced-summation contact lens pair 300 to provide enhanced near-distance vision as discussed above, the center-near zone diameter D_{CNZ} of the center-near optical zone 312 (which has an add power for correction of presbyopia) is optimized. The center-near zone diameter D_{CNZ} of the center-near optical zone 312 is sized based on the estimated diameter size of a constricted pupil when a wearer focuses on a near-distance object (e.g., at 2.5 diopters). The center-near zone diameter D_{CNZ} of the center-near optical zone 312 is increased as compared to conventional multi-focal lenses to approximate an average or mean diameter of an individual's pupil based on the anticipated pupil miosis, lighting conditions, and/or as spherical aberrations that naturally occur in an individual's ocular system when focusing on near-distance objects to achieve superior near-distance vision like monovision. For example, as discussed in more detail below, the center-near zone diameter D_{CNZ} of the center-near optical zone 312 may be sized to a diameter between 2.6 and 4.0 mm based on pupil miosis studies of the average or mean diameter size of a pupil when focusing near-distance object (e.g., >=2.5 diopters) and based on different lighting conditions. Optimizing the center-near zone diameter D_{CNZ} of the center-near optical zone 312 in the center-near lens 304 takes advantage of the fact that due to pupil miosis, the pupil constricts when the eye focuses on nearer distance objects. Because the center-near zone diameter D_{CNZ} of the center-near lens 304 is sized so that the diameter of the pupil of a wearer is more closely matched to the size of the center-near optical zone 312 when focusing on near-distance objects, either none or less light will pass through the transitional optical zones 314(1)-314(3) of the center-near lens 304 to the pupil of the non-dominant eye of the wearer as will pass through the center-near optical zone 312. This is shown by example in FIG. 4A, which is a schematic diagram of the dominant eye, center-far and non-dominant eye, center-near contact lenses 302, 304 in FIG. 3 as worn by an exemplary contact lens wearer when focusing on a near-distance object.

As shown in FIG. 4A, the diameter D_{PN} of the wearer's non-dominant eye pupil 400 and dominant eye pupil 404 of the respective non-dominant and dominant eyes 402, 406 constricts due to pupil miosis when the wearer is focusing on a near-distance object. The size of the center-near zone diameter D_{CNZ} (e.g., between 2.6 and 4.0 mm) of the center-near optical zone 312 is designed to closely approximate the constricted diameter D_{PN} of the wearer's non-dominant eye pupil 400 at near-distance vision (e.g., >=2.5 diopters). This design of the center-near lens 304 provides for the constricted non-dominant eye pupil 400 to receive either all or a majority of light through the center-near optical zone 312 when the wearer is focused on a near-distance object. This enables the enhanced-summation contact lens pair 300 to emulate monovision at near distances with higher VA and contrast, because (1) either all or a majority of light (in this example) received by the constricted non-dominant eye pupil 400 focused on a near-distance object is received through the center-near optical zone 312 that corrects for near-distance viewing and (2) either all or a majority of light (in this example) received by the constricted dominant eye pupil 404 focused on a near-distance object is received through the center-far optical zone 306 that is corrected for far-distance vision. The center-near optical zone 312 not only has the refractive correction power for the wearer but also has the add power for correction of presbyopia.

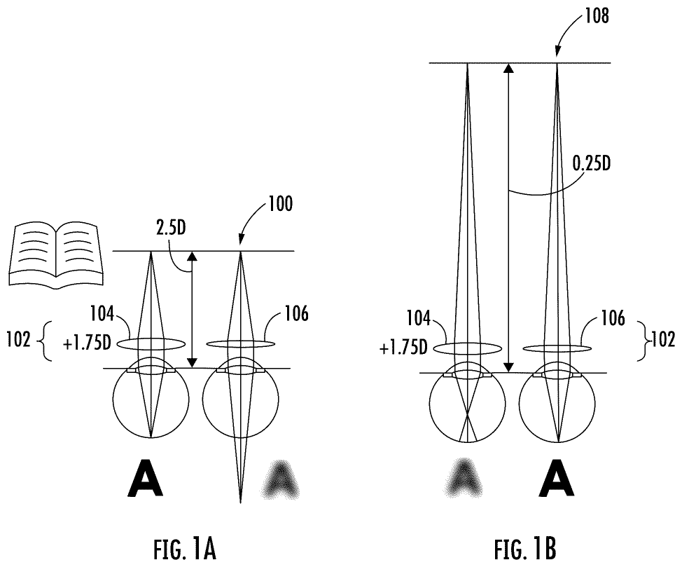

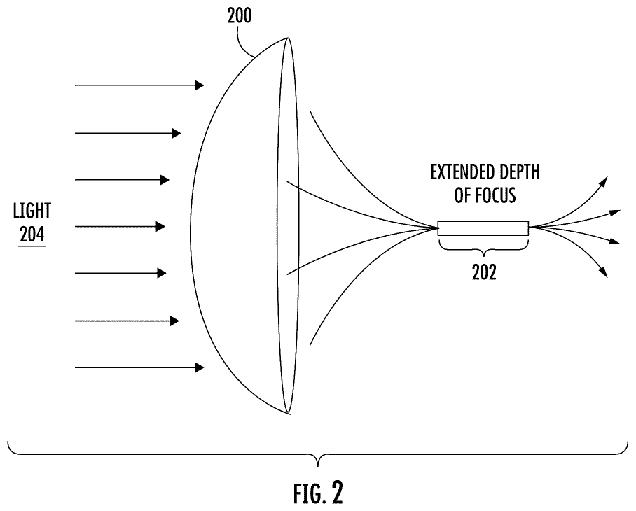

Thus, as shown in FIG. 4A, more light is received by the constricted dominant eye pupil 404 through the transitional zone(s) 308 of the center-far lens 302 than is received by the constricted non-dominant eye pupil 400 through the transitional zone(s) 314 of the center-near lens 304 at near-distance vision. This is due to the sizing of the center-near zone diameter D_{CNZ} of the center-near optical zone 312 to approximate or be closer to the average constricted pupil diameter D_{PN} of the non-dominant eye pupil 400. Thus, the VA of an image from light received through the center-far lens 302 in the wearer's dominant eye 406 when focusing on a near-distance object will be less than an image from light received through the center-near lens 304 in the wearer's non-dominant eye 402. Thus, there will be a rather large disparity of VA between an image from light received through the center-far lens 302 in the wearer's dominant eye 406 and an image from light received through the center-near lens 304 in the wearer's non-dominant eye 402. This provides a higher VA and contrasts single focality image from received light passing predominantly through the center-near optical zone 312 of center-near lens 304 in the non-dominant eye 402, similar to near-distance monovision provided by a monovision lens for near-distance vision as shown in FIG. 1A for example. This is because the wearer's brain will process the focused image of higher VA from light predominantly received in the non-dominant eye 402 of the wearer through the center-near optical zone 312 of the center-near lens 304 over a reduced VA image from light received in the dominant eye 406 of the wearer through the center-far optical zone 306 of the center-far lens 302.

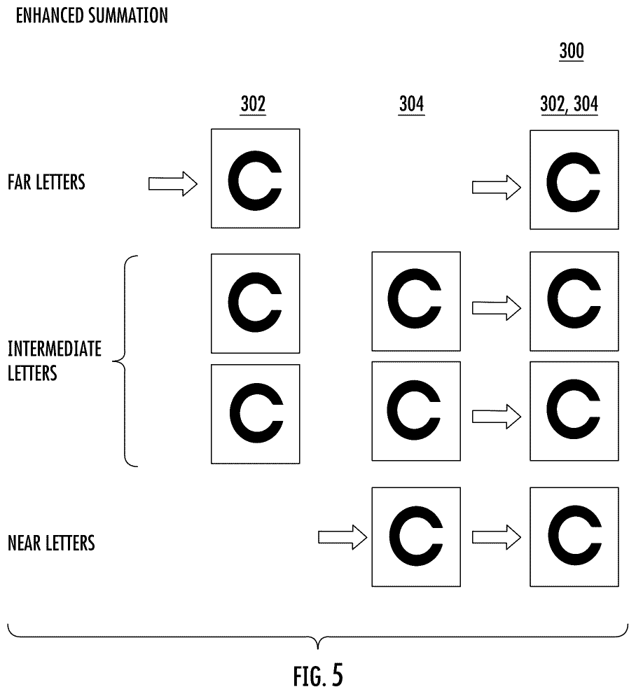

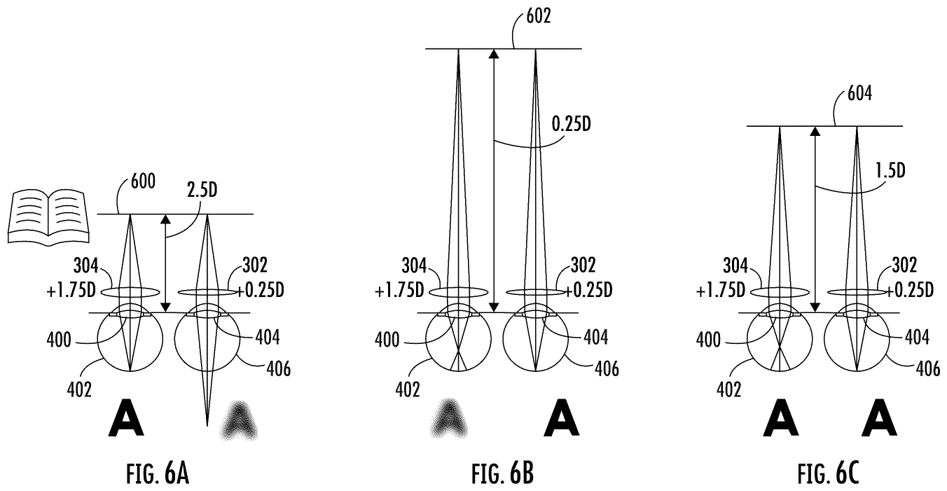

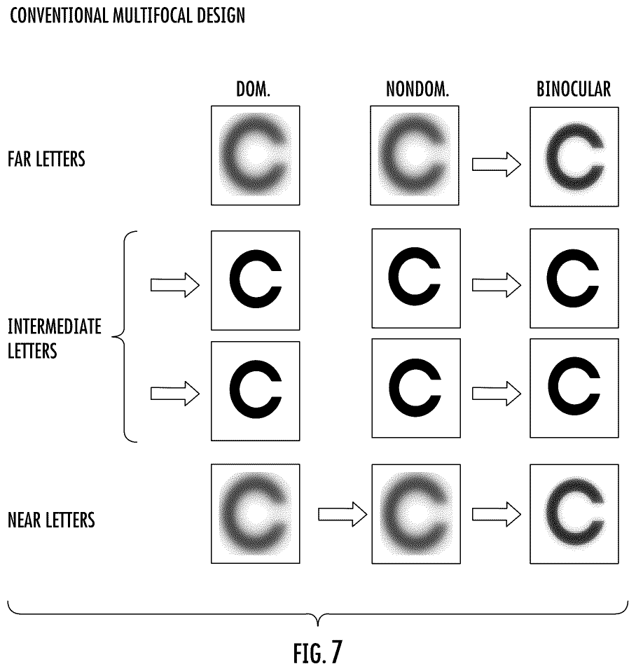

This is also shown in FIG. 5, where the wearer of the enhanced-summation contact lens pair 300 experiences a high VA and contrast in images from near-distance vision through the center-near non-dominant eye lens 304, as shown by the high VA and contrast letters shown as “Near letters” therein. This is also shown in FIG. 6A that shows a wearer focusing on a near-distance object 600 (e.g., at 2.5 diopter) through the center-far and center-near lenses 302, 304 in the respective dominant and non-dominant eyes 406, 402 of the wearer. This is contrasted with FIG. 7, which shows an exemplary lower VA and contrast of near-distance vision as shown by the “Near letters” for a conventional multi-focal contact lens pair that does not employ a center-far dominant, center-near non-dominant eye lens design. As shown in FIG. 4A, the center-far lens 302 will not provide a high VA and contrast image to the wearer at near-distance vision because the center-far optical zone 306 of the center-far lens 302 does not have the add power provided in the center-near optical zone 312 of the center-near lens 304 in this example. Note that it is possible to also provide some add power in the center-far optical zone 306 of the center-far lens 302 if desired. The significant VA difference between dominant eye and non-dominant eye makes the lens pair work as monovision at near-distance vision.

Referring now to FIG. 4B, when the wearer focuses on a far-distance object (e.g., <=0.25 diopters), the wearer's pupils 400, 404 dilate to a dilated pupil diameter D_{PF} due to pupil miosis. At far-distance vision, the patient's pupils dilate to a larger diameter size with a longer depth of focus in both the dominant and non-dominant eye. The dilated pupil diameter D_{PF} of dilated pupils 400, 404 of the non-dominant and dominant eyes 402, 406 is much larger than the center-near zone diameter D_{CNZ} and the center-far zone diameter D_{CFZ} of the respective center-near and center-far optical zones 312, 306 of the center-near and center-far lenses 304, 302. Thus, when the wearer is focused on a far-distance object (e.g., <=0.25 diopter), some light received by the dominant eye pupil 404 will be through the center-far optical zone 306 of the center-far lens 302. As discussed previously, the center-far optical zone 306 of the center-far lens 302 has a first power for correction of vision at an optimized far distance (e.g., 0.25 diopters). This center-far optical zone 306 provides distance correction for enhanced far-distance vision like far-distance monovision (defined as “partial monovision”). This is also shown in FIG. 5, where the wearer of the contact lens pair 300 experiences a high VA and contrast in images from far-distance vision through the center-far dominant eye lens 302 as shown by the high VA and contrast letters shown as “Far letters” therein. This is also shown in FIG. 6B, which shows a wearer focusing on a far-distance object 602 (e.g., at 0.25 diopter) through the center-far and center-near lenses 302, 304 in the respective dominant and non-dominant eyes 406, 402 of the wearer. This is contrasted with FIG. 7, which shows an exemplary lower VA and contrast of far-distance vision as shown by the “Far letters” for a conventional multi-focal contact lens pair that does not employ a center-far dominant eye, center-near non-dominant eye lens design.

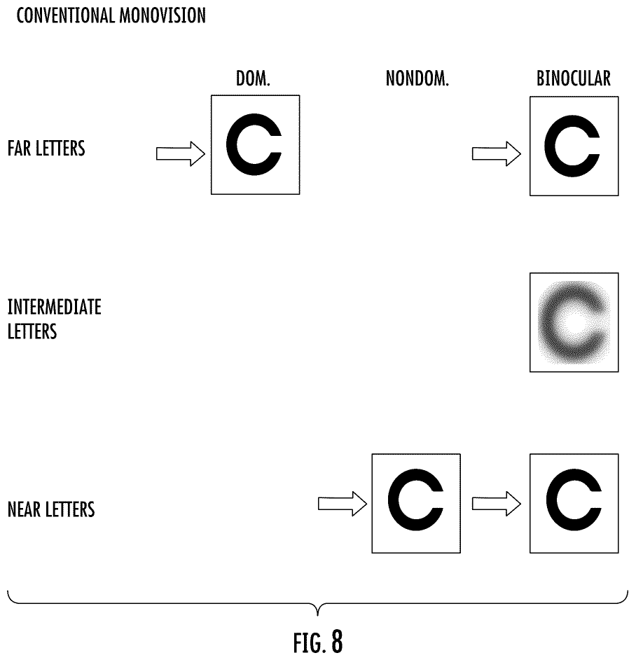

But as also shown in FIG. 4B, when the wearer is focused on a far-distance object such that their dominant eye pupil 404 is dilated, light is also received by the dominant and non-dominant eye pupils 404, 400 through their transitional optical zones 308, 314 of the respective center-far and center-near lenses 302, 304. More light is received by the dominant and non-dominant eye pupils 404, 400 through their transitional optical zones 308, 314 of the respective center-far and center-near lenses 302, 304 than received when the wearer's dominant and non-dominant eye pupils 404, 400 are constricted when focusing on a near-distance object. This also provides higher VA and contrast images at far distances through partial monovision, previously discussed above. This is because, as discussed above, while light is received through the center-far optical zone 306 as a form of far-distance monovision when the wearer is focused on far-distance objects, a multi-focality of light is also received through the transitional optical zones 308, 314 of the lens pair 300 in an EDOF. This light received through the center-far optical zone 306 of the center-far lens 302, and from the transitional optical zones 308, 314 of the center-far and center-near lenses 302, 304 are combined (binocular summation) by the wearer's brain to provide a summed image for enhanced far-distance vision to provide partial monovision. The wearer's brain can combine the higher VA and contrast light received through the center-far optical zone 306 of center-far lens 304 as well as the light in an EDOF received through the transitional optical zones 308, 314 of the center-far and center-near lenses 302, 304 to provide a high VA and contrast image. This is also shown in FIG. 5, where the wearer of the contact lens pair 300 experiences a high VA and contrast in images from far-distance vision through monovision through the center-far lens 302 as shown by the high VA and contrast letters shown as “Far letters” therein. This is also shown in FIG. 5, where the wearer of the contact lens pair 300 experiences a high VA and contrast in images from intermediate-distance vision through the EDOF provided by the multi-focality of the center-far and center-near lenses 302, 304 as shown by the high VA and contrast letters shown as “Intermediate letters” therein. This is also shown in FIGS. 6B and 6C, which show a wearer focusing on a respective far-distance object 602 (e.g., at 0.25 diopters) and intermediate-distance object 604 (e.g., at 1.5 diopters) through the center-far and center-near lenses 302, 304 in the respective dominant and non-dominant eyes 406, 402 of the wearer. This is contrasted with FIG. 8, which shows an exemplary lower VA and contrast of intermediate-distance vision as shown by the “Intermediate letters” for a conventional monovision lens pair strategy that does not employ enhanced-summation lenses or a center-far dominant, center-near non-dominant enhanced-summation lens design like shown for example in enhanced-summation contact lens pair 300 in FIGS. 3.

Also, in the example of the enhanced-summation contact lens pair 300 in FIG. 3, enhanced intermediate-distance vision is achieved through binocular summation and multi-focality based on optimizing transitional optical zones 308, 314 in both the center-far dominant and center-near non-dominant eye lenses 302, 304 such that contact lens pair 300 to provide an EDOF. In this regard, when the non-dominant and dominant eyes 402, 406 shown in FIGS. 4A and 4B are focused on intermediate-distance objects, the pupils 400, 404 of both the dominant and non-dominant eyes 402, 406 dilate to a diameter to receive a significant amount of light in an EDOF through the transitional optical zone 308, 314 of both the center-far and center-near lenses 302, 304. Further, the received light through these transitional optical zones 308, 314 of the center-far and center-near lenses 302, 304 when the wearer is focused on intermediate distances is also of reduced disparity (i.e., reduced stereopsis) in VA to improve intermediate distance vision. This is also in part because the non-dominant eye pupil 400 receives less light through its transitional optical zone 314 due to the larger center-near zone diameter D_{CNZ} of the center-near optical zone 312 of the center-near lens 304 than is received by the center-far optical zone 306 of the center-far lens 302 having a larger center-far zone diameter D_{CFZ}. This increases the size of the transitional zone 308 in the center-far lens 302 to provide an increased amount of light received through the transitional zone 308 of the center-far lens 302 for an even further reduced disparity in VA of light received by both lenses 302, 304. This provides a reduced disparity in VA of images to the wearer from light received through the center-far and center-near lenses 302, 304 of the lens pair 300. The received light of reduced disparity in VA, when the wearer is focused on intermediate distances, can more easily be summed by the wearer's brain for a higher VA to provide enhanced binocular summation at intermediate distances over conventional monovision lens pairs. An individual's brain can more easily and effectively process sum images in the dominant and non-dominant eyes 406, 402 of reduced disparity in VA to provide an improved clarity and contrast image of intermediate-distance objects.

This is also shown in FIG. 5, where the wearer of the contact lens pair 300 experiences a high VA and contrast in images from intermediate-distance vision through binocular summation through the center-far and center-near lenses 302, 304 as shown by the high VA and contrast letters shown as “Intermediate letters” therein. This is contrasted with FIG. 8, which shows an exemplary lower VA and contrast of intermediate-distance vision as shown by the “Intermediate letters” for a conventional monovision lens pair strategy that does not employ enhanced-summation lenses or a center-far dominant, center-near non-dominant enhanced-summation lens design like shown for example in enhanced-summation contact lens pair 300 in FIG. 3. As illustrated in FIG. 5, the center-far lens 302 fitted to the dominant eye, when used alone, provides correction for distance vision and intermediate vision but does not provide correction, or sufficient correction, for near vision. Similarly, the center-near lens 304, fitted to the non-dominant eye, provides correction for near vision and intermediate vision but does not provide correction, or sufficient correction, for distance vision.

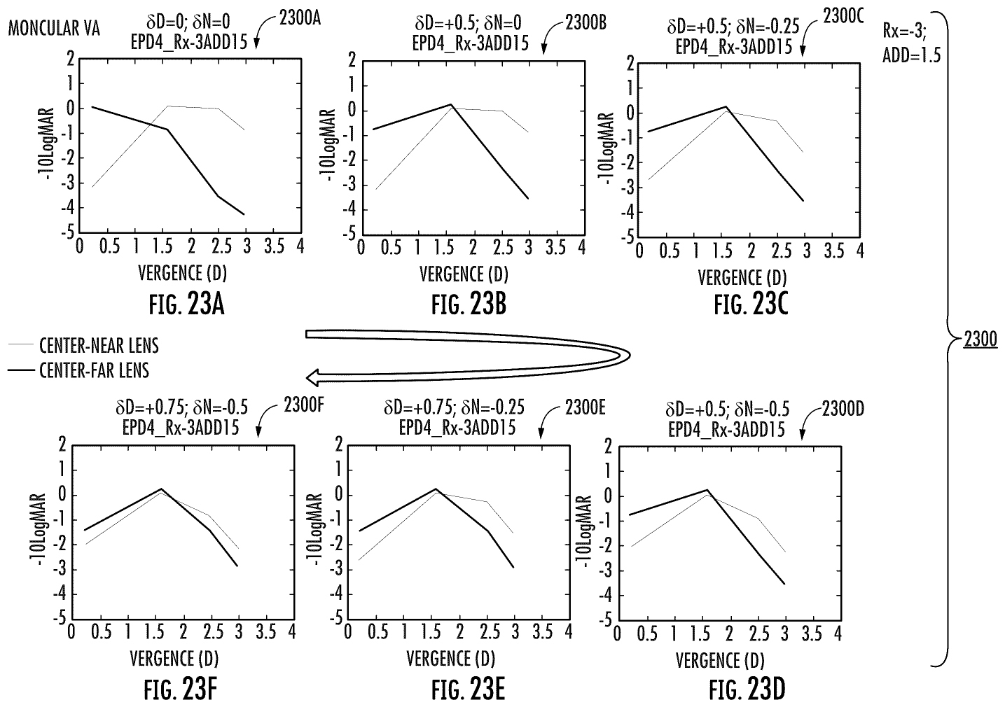

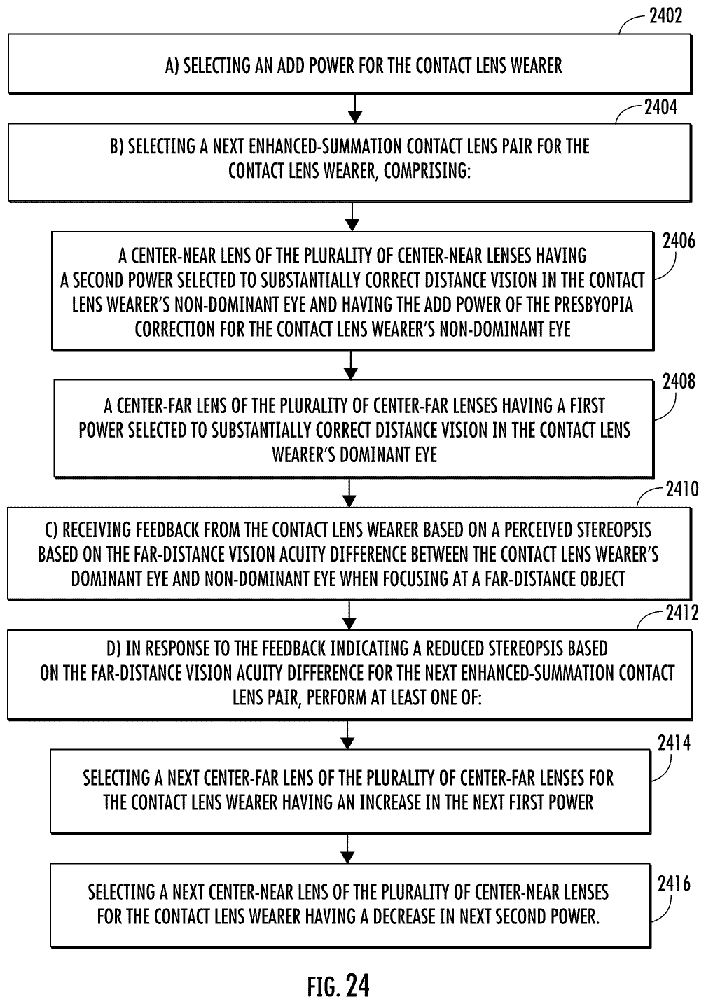

More exemplary details of enhanced-summation contact lens pairs that include a center-far dominant eye lens and center-near non-dominant lens, like the enhanced-summation contact lens pair 300 in FIG. 3, are optimized and fitted to a wearer as a binocular system such that the wearer experiences superior presbyopia-corrected near-distance vision like that of monovision, but also with enhanced intermediate-distance vision through binocular summation and far-distance vision through partial monovision are now described with regard to FIGS. 9-22B. FIGS. 23A-24 are then discussed as exemplary processes of fitting an enhanced-summation contact lens pair in an enhanced-summation contact lens pair system that includes a plurality of the enhanced-summation contact lens pairs to provide the contact wearer with improved VA and near-distance, intermediate-distance, and far-distance visions.

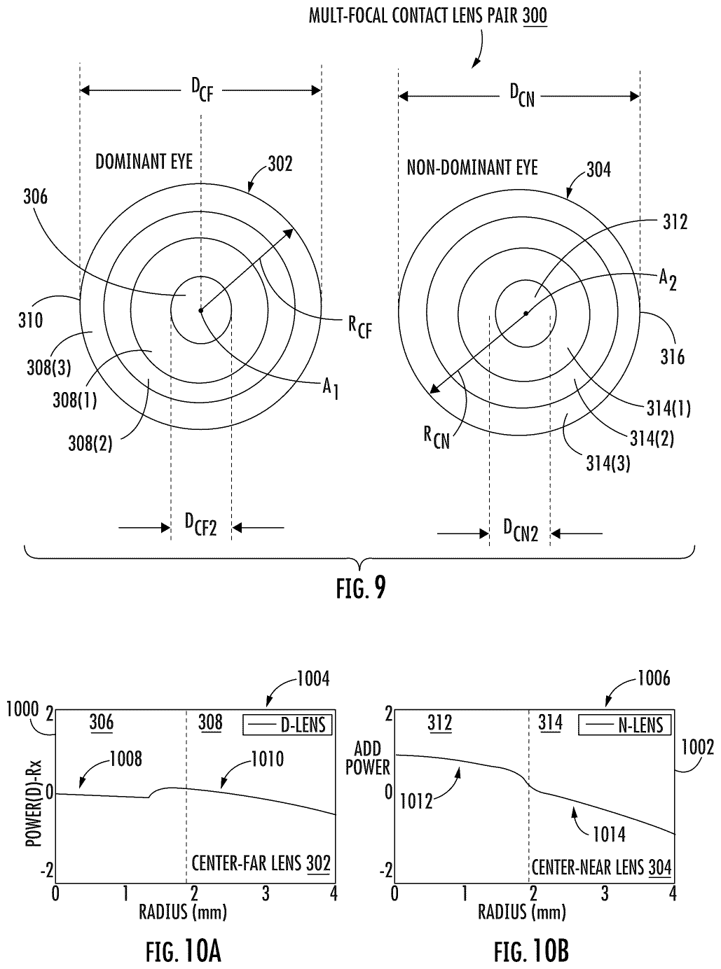

FIGS. 10A and 10B are graphs 1000, 1002 illustrating an exemplary normalized power profiles 1004, 1006 normalized without addition of any corrective prescription as function of radius of the respective center-far dominant eye lens 302 and the center-near non-dominant eye lens 304 in FIG. 3. Normalized power means a lens label refractive correction power is subtracted. Note that in an actual power profile of a lens for a patent, any refraction correction power will be included to the power profile. The schematic diagrams in FIG. 3 of the center-far dominant eye lens 302 and the center-near non-dominant eye lens 304 are repeated in FIG. 9 for convenience. As shown in the graph 1000 in FIG. 10A, the overall power profile 1004 of the center-far lens 302 (Y-axis) includes a center-far power profile 1008 of the center-far optical zone 306 of the center-far dominant eye lens 302 is shown between radius of 0 mm and approximately 1.3 mm (or 2.6 mm diameter) (X-axis). The center-far power profile 1008 of the center-far optical zone 306 has an almost spherical first power of 0 diopters as normalized to be independent of any refractive power. In this example, the center-far optical zone 306 has a greater diameter than the center-near optical zone 312 in the center-near lens 304 for the reasons previously discussed above. As also shown in FIG. 10A, the center-far power profile 1008 of the center-far optical zone 306 of the center-far lens 302 has a power profile that has spherical aberration (SPHA) to account for spherical aberrations that naturally occur in an individual's ocular system when focusing on far-distance objects. As an example, the center-far power profile 1008 of the center-far optical zone 306 of the center-far lens 302 may have a SPHA dependent on the first power prescription or lens labeled power (Rx) is as follows:

$$a . if Rx \leq - 3 diopters , then S P H A = 0.0082 * Rx - 0.0251 ;$$

$$and$$

$$b . if Rx > - 3 diopters , then S P H A = - 0.0497$$

As also shown in FIG. 10A, the overall power profile 1004 of the center-far lens 302 also has a transitional power profile 1010 in the transitional optical zone 308 of the center-far lens 302. The transitional power profile 1010 of the transitional optical zone 308 has a SPHA to account for spherical aberrations that naturally occur in an individual's ocular system of the wearer's non-dominant eye that affects received light from focused intermediate-distance and far-distance objects.

Also, as shown in FIG. 10B, the overall power profile 1006 of the center-near lens 304 includes a center-near power profile 1012 of the center-near optical zone 312 of the center-far dominant eye lens 302 of prescription power (Y-axis) between radius of 0 mm and approximately 2.0 mm (or 4.0 mm diameter) (X-axis). As discussed previously, the center-near optical zone 312 and its center-near power profile 1012 is sized in diameter to approximate an individual's pupil diameter when focused on a near-distance object due to pupil miosis to provide enhanced near-distance vision like monovision through the center-near lens 304 in the wearer's non-dominant eye. In this example, as previously discussed, the center-near optical zone 312 has a larger diameter than the center-far optical zone 306 in the center-far lens 302. The center-near power profile 1012 of the center-near optical zone 312 has a spherical aberration (SPHA) 304 to account for spherical aberrations that naturally occur in an individual's ocular system that affect received light from focused near-distance objects. As also shown in FIG. 10B, the overall power profile 1006 of the center-near lens 304 also has a transitional power profile 1014 in the transitional optical zone 314 of the center-near lens 304. The transitional power profile 1014 of the transitional optical zone 314 has a SPHA to account for spherical aberrations that naturally occur in an individual's ocular system that affect received light in the wearer's non-dominant eye from focused intermediate-distance and far-distance objects. For example, the center-near power profile 1012 may include the center-near optical zone 312 within a 2.0 mm radius, which contains more than 65% exactly percentage number depending on add power and SKUs of the add power), and a transitional power profile 1014 with a transitional zone from 2.0-3.0 mm diameter containing less than 35% of the add power and above a 6 mm diameter, a transitional zone is designed to correct patient's far-distance vision refractive power and spherical aberration and has zero add power.

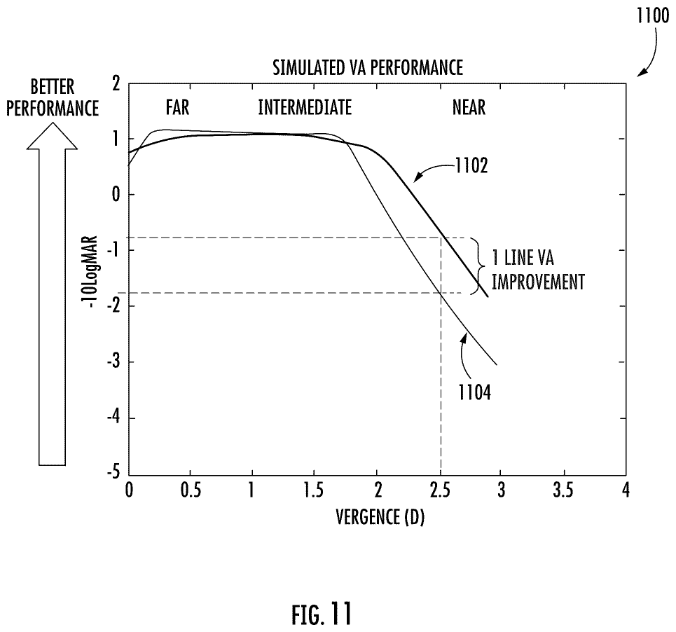

FIG. 11 is a graph 1100 illustrating an exemplary VA performance (Y-axis) as a function of vergence (D) (X-axis) over far-distance, intermediate-distance, and near-distance vision with the enhanced-summation contact lens pair 300 of dominant eye, center-far and non-dominant eye, center-near lenses 302, 304 in FIG. 3, as compared to a conventional center-near multi-focal lenses. The VA (VA) (in a −10 LogMAR unit) performance of the enhanced-summation contact lens pair 300 is shown in VA curve 1102. The VA performance of an alternative multi-focal lens pair that employs a center-near optical zone in all lenses for both the dominant and non-dominant eye of the wearer is shown in VA curve 1104. For example, the multi-focal lens pair illustrated by the VA performance in VA curve 1104 may be the 1-day Acuvue® moist presbyopia contact lens pair which has a center-near EDOF for both dominant and non-dominant eye. In the non-dominant eye, center-near, lens for the 1-day Acuvue® moist presbyopia contact lens pair, the majority of the add power (e.g., >=65%; e.g., 88%) is within the center 2.0 mm radius of the lens, and the remainder of the add power is provided with the first 3.00 mm radius of the lens. As shown in VA curves 1102 and 1104 in FIG. 11, the VA at near distances (e.g., above 1.75 diopter) for the enhanced-summation contact lens pair 300 is at least a 0.8 line improvement over the 1-day Acuvue® moist presbyopia contact lens pair. At shown by VA curves 1102, 1104, a near distance of 2.5 diopter, the enhanced-summation contact lens pair 300 has a VA improvement over the 1-day Acuvue® moist presbyopia contact lens pair of approximately 1.0 VA. As also shown in the VA curves 1102 and 1104 in FIG. 11, the VA at far distances (e.g., <1.0 diopter) for the enhanced-summation contact lens pair 300 may not be an improvement over (or non-inferior to) the 1-day Acuvue® moist presbyopia contact lens pair in an example, because both lenses are based on providing far-distance vision based in of a combined multi-focality of light having an EDOF.

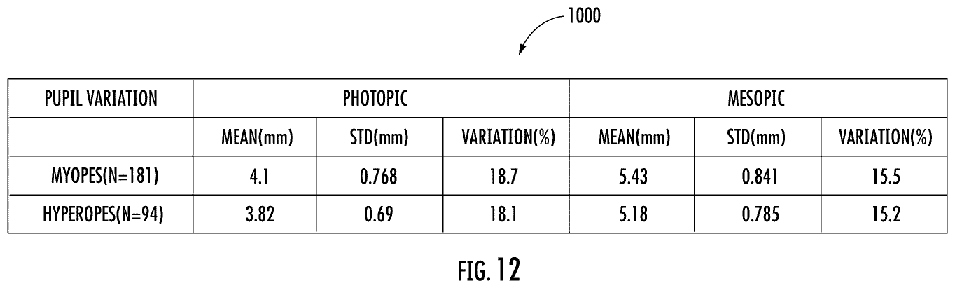

As discussed previously above, the center-near optical zone 312 of the center-near lens 304 in FIG. 3 is designed to include a factor of an average or mean diameter of an individual's pupil based on the anticipated pupil miosis to achieve superior near-distance vision like monovision. Studies were performed for a variety of patients in both photopic and mesopic conditions to determine metrics regarding pupil diameter and variations in pupil diameter when focused on near-distance objects (e.g., at 2.5 diopter). These results are shown in the table 1200 in FIG. 12, that illustrates an exemplary mean pupil diameter size as well as standard deviation and variation based a pupil size for study of myope and hyperope subjects in photopic and mesopic conditions. The study is entitled “Evaluation of the visual performance of a new multifocal contact lens and the impact of refractive error” in Contact Lens and Anterior Eye, Volume 41, Supplement 1, S24, Jun. 1, 2016 (https://www.contactlensjournal.com/article/$1367-0484(18)30689-1/fulltext) by Moody et al., which is incorporated herein by reference in its entirety. As shown in FIG. 12, the mean diameter of the pupil in 181 myopes studied in photopic conditions was 4.1 mm, whereas the mean diameter of the pupil in the hyperopes studied in photopic conditions was 3.82 mm. As also shown in FIG. 12, the mean diameter of the pupil in the myopes studied in mesopic conditions was 5.43 mm, whereas the mean diameter of the pupil in 94 hyperopes studied in mesopic conditions was 5.18 mm. Thus, as discussed in more detail below, the center-near diameter of the center-near optical zone 312 of the center-near lens 304 was selected to be based on multiple pupil sizes based on the variation in pupil diameter that can occur in different conditions and as affected by accommodation lead/lag, and lens/eye wavefront interaction refraction. For example, the center-near zone diameter D_{CNZ} of the center-near optical zone 312 of the center-near lens 304 can be selected to be between 2.6 and 4.0 mm. Further, the center-near zone diameter D_{CNZ} of the center-near optical zone 312 of the center-near lens 304 can be selected to be between 2.6 and 4.0 mm. The center-near zone diameter D_{CNZ} can be selected to be different for myope and hyperope prescriptions based on the study of pupil diameter size and variation between myopes and hyperopes, as shown in the study in FIG. 12, for example (4.1 mm vs. 3.82 mm). Alternatively, to reduce SKUs, a compromise between myope and hyperope prescriptions can be provided by providing a single-diameter center-near zone diameter D_{CNZ} in the center-near lens 304 for myope and hyperope prescriptions. The study of pupil miosis can also be based on an average pupil size of any size population, including a population as small as the size of one (1), for example.

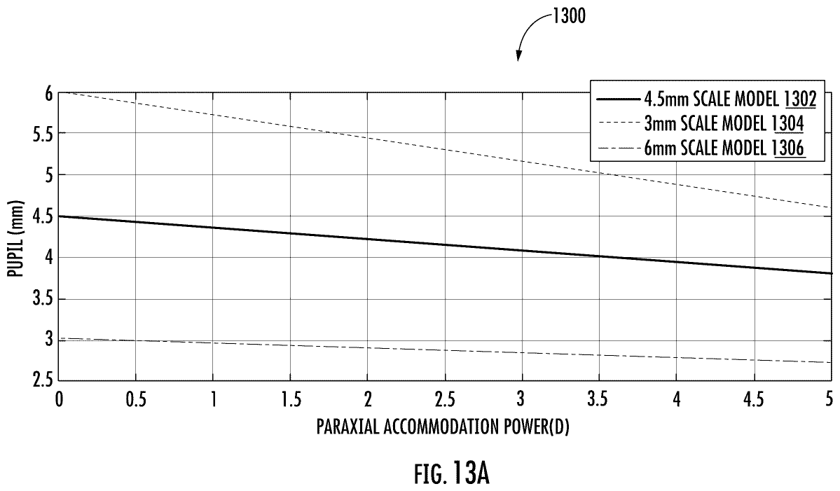

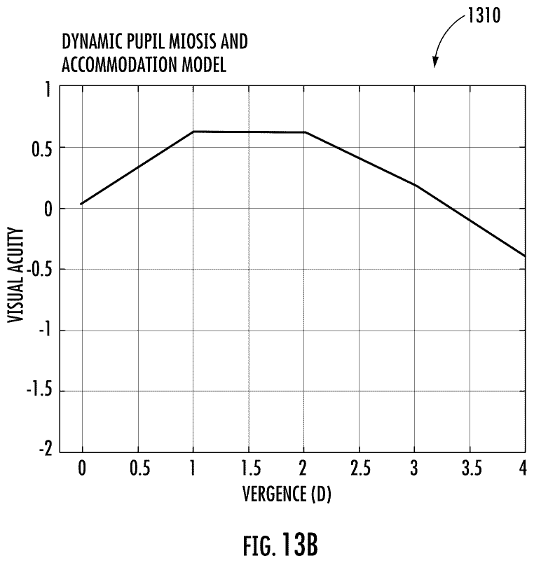

FIG. 13A is a graph illustrating exemplary dynamic pupil miosis model 1300 showing a modeling average pupil diameter (Y-axis) as a function of paraxial accommodation power (X-axis). The paraxial accommodation power is a representation of the distance of an object focused on by an individual. The dynamic pupil miosis model 1300 illustrates modeling of average pupil diameter as a function of paraxial accommodation power (focused distance) that may be used to decide the sizing of the diameter of a center-near optical zone in a center-near lens for the enhanced-summation contact lens pair 300. As illustrated in dynamic pupil miosis model 1300, the dynamic pupil miosis model includes curves 1302, 1304, 1306 that each model changes in pupil diameter size as a function of focused distance for different dilated pupil diameters at a given focused distance. Curve 1302 shows a constricted pupil diameter of approximately 4.5 mm at a 0 diopter focused distance. Curve 1304 shows a constricted pupil diameter of approximately 3.0 mm at a 0 diopter focused distance. Curve 1306 shows a constricted pupil diameter of approximately 6.0 mm at a 0 diopter focused distance. Then, as shown in each of the curves 1302-1306, the pupil diameter size constricts as the individual focuses at a nearer distance object. This exemplary dynamic pupil miosis model in FIG. 13A can be used to determine an average center-near zone diameter D_{CNZ} of the center-near optical zone 312 of the center-near lens 304. For example, a focused distance of 2.5 diopters may be used from the dynamic pupil miosis model 1300 in FIG. 13 to determine an optimized center-near zone diameter D_{CNZ} size of the center-near optical zone 312 of the center-near lens 304.

FIG. 13B is a graph 1310 illustrating an exemplary VA as a function of vergence based on the dynamic pupil miosis model in FIG. 13A. The X-axis of the graph 1310 in FIG. 13B is target object vergence in diopter unit, and the Y-axis of graph 1310 is the VA in a −10 LogMAR unit. When computing the VA, the accommodation introduced pupil miosis, the interaction among a lens design and ocular wavefront aberration, and patient's pupil size are considered. The details of this model have been published with the title of “Modelling the impact of spherical aberration on accommodation,” Ophthalmic & Physiological Optics, 2013, 33, 482-496., which is incorporated herein by reference in its entirety.

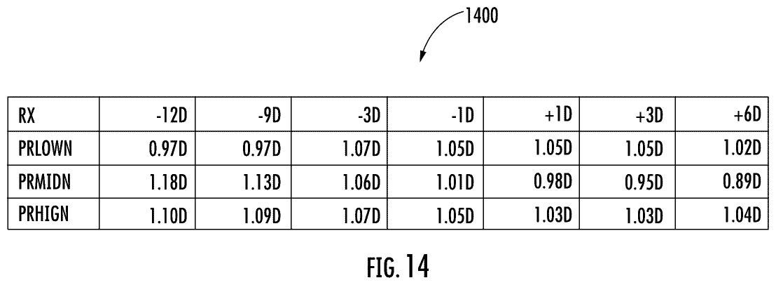

FIG. 14 illustrates a chart 1400 of exemplary actual add power to a center-near optical zone of a center-near non-dominant eye lens like the center-near lens 304 in FIG. 3 to correct for presbyopia in monovision as a function of corrective prescription. The add power in the chart 1400 was determined based on the modeling of center-near non-dominant eye lenses based on determined diameter of the center-near zone for the center-near lens based on the pupil miosis study in FIG. 12 as well as pupil miosis accommodation model in FIG. 13A and the dynamic pupil miosis and accommodation model and pupil size in FIG. 13B. As shown in FIG. 14, add powers for a low-add power (PRLOWN), mid-add power (PRMIDN), and high-add power (PRHIGN) center-near lens with a center-near optical zone having a diameter modeled based on anticipated pupil diameter when focused on near-distance objects is shown over correction prescriptions of −12 diopters, −9 diopters, −3 diopters, −1 diopters, +1 diopters, +3 diopters, and +6 diopters. In this example, the enhanced-summation contact lens pairs are provided for 3 patient's add power ranges of low (e.g., patient's add power can be 0.75, 1.0, or 1.25 diopters), mid (e.g., patient's add power can be 1.5 or 1.75 diopters), and high-add (e.g., patient's add power can be 2.0, 2.25, and 2.5 diopters) powers. These selections may be based on the desired to provide an enhanced-summation contact lens pair system that includes multiple enhanced-summation contact lenses like in FIG. 3 for different prescriptive SKUs and for different patient's add power needs, but may also be practically limited to three (3) different effective add powers, for reduction in complication in fitting a wearer as well as to minimize the overall number of SKUs.

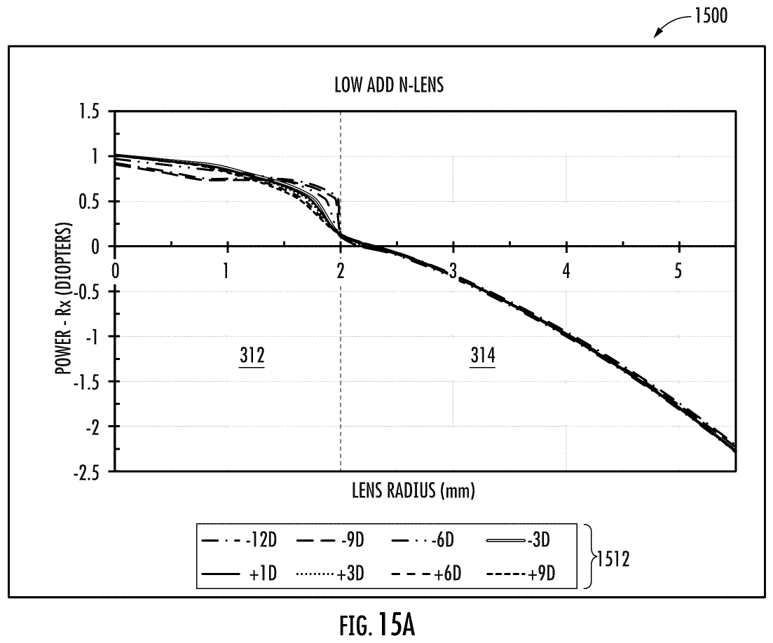

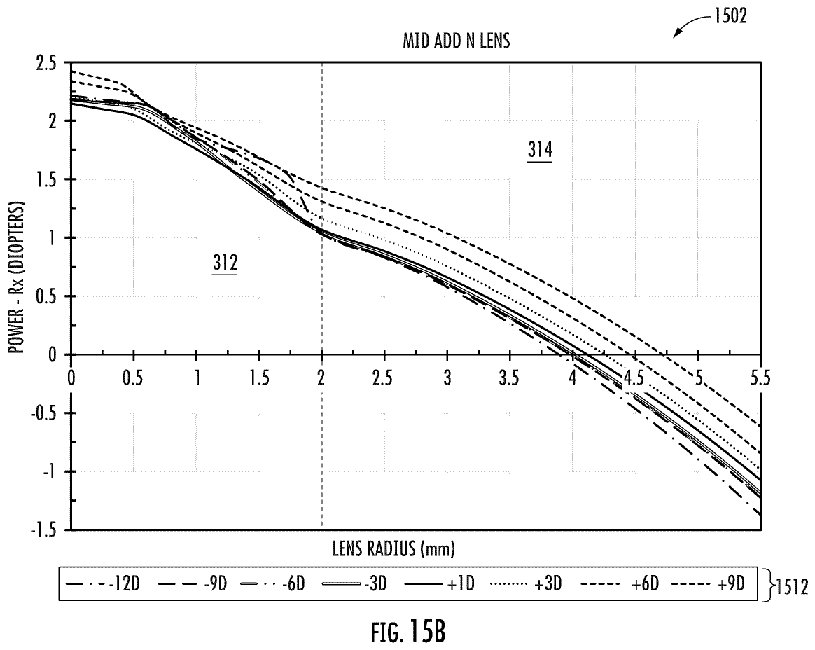

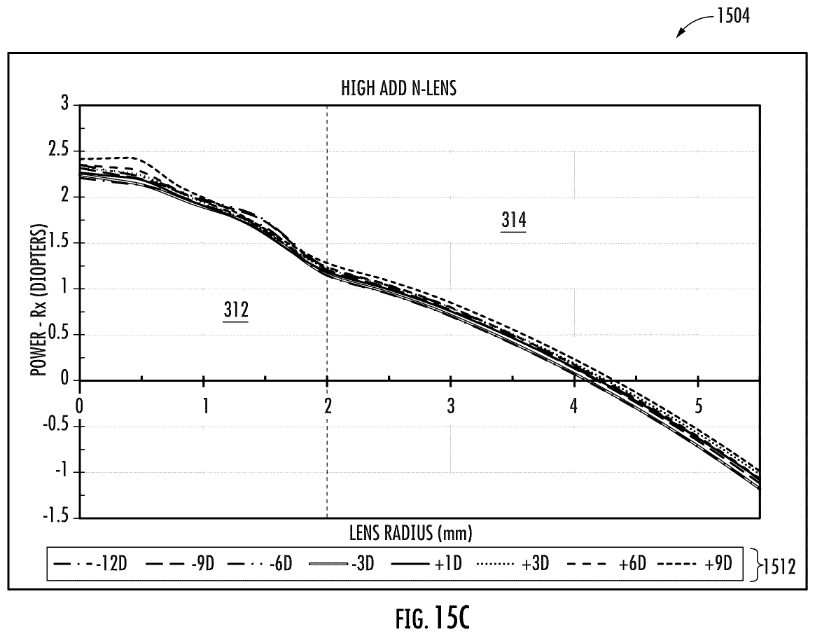

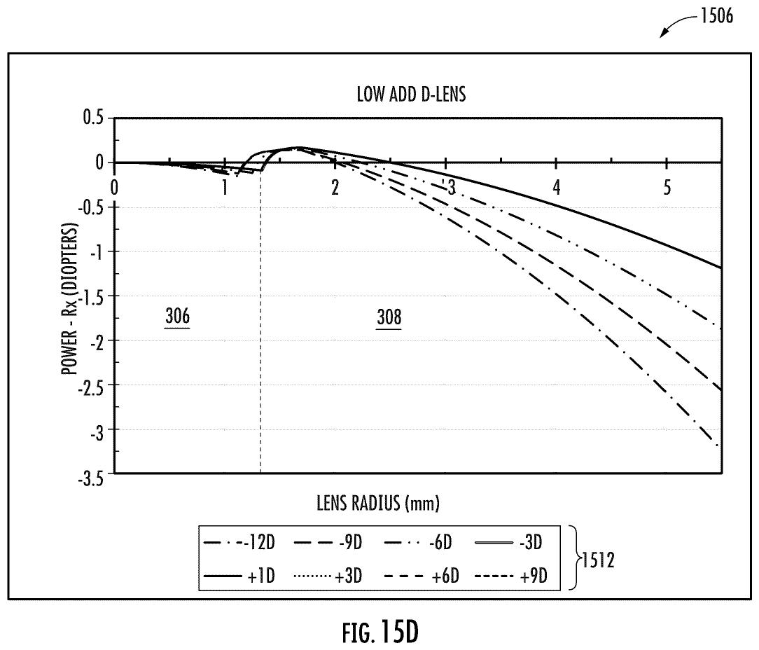

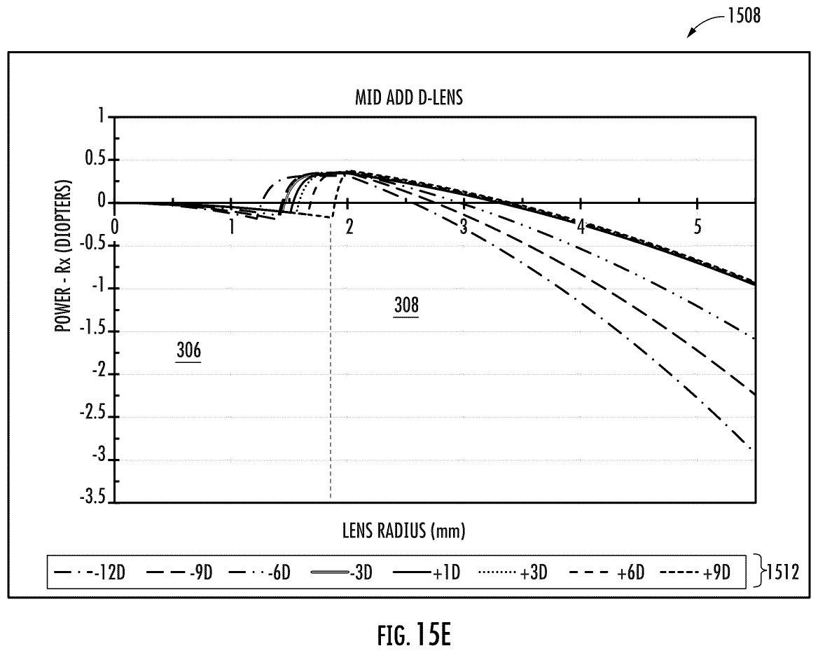

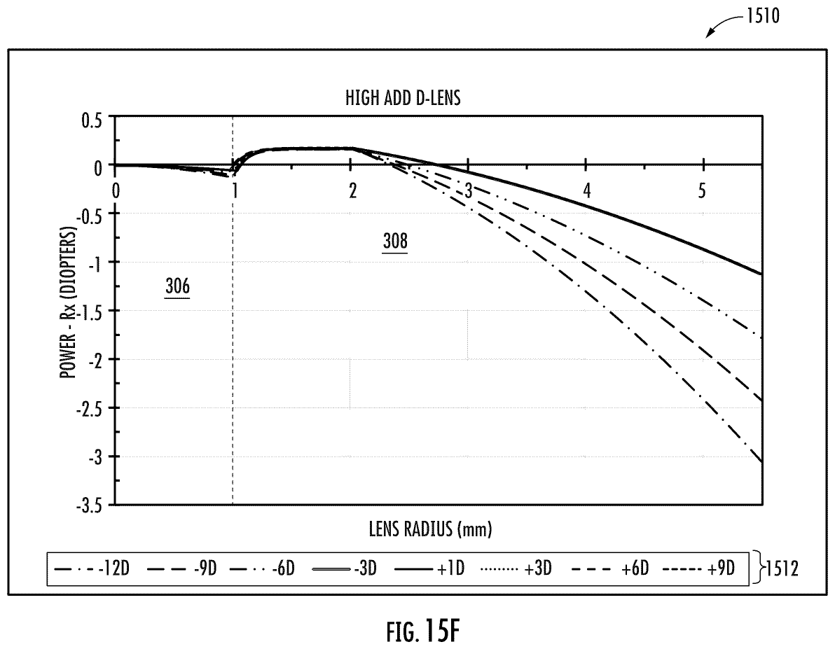

To further illustrate an exemplary enhanced-summation contact lens pair system that includes pairs of center-near non-dominant eye and center-far dominant eye lenses that are provided to have three (3) add powers of accommodation for presbyopia and over a prescription SKU between −12 diopters and +9.0 diopters, FIGS. 15A-15F are provided. FIGS. 15A-15C are power profiles 1500, 1502, 1504 of exemplary respective low-add, mid-add, and high-add power, power profiles of a center-near non-dominant eye lenses (labeled N-LENS) like in FIG. 3, as a function of lens radius and across a range of different refractive correction powers, to illustrate the center-near power profile with paraxial low, mid, and high add power in the center-near optical zone and the power profile of the transitional zone. FIGS. 15D-15F are power profiles 1506, 1508, 1510 of exemplary respective low-add, mid-add, and high-add power, power profiles as a function of lens radius of a center-far dominant eye lens (labeled D-LENS) like in FIG. 3 across a range of refractive correction powers, to illustrate the center-near power profile with paraxial low, mid, and high-add power in the center-near optical zone and the power profile of the transitional zone.

As shown in the example in FIG. 15A, the low-add power profile 1500 for a low-add power center-near non-dominant eye includes a center-near optical zone 312 with a center-far zone diameter of 4.0 mm, a transitional optical zone 314 having a transitional diameter between 4.0 and 6.0 mm, and add power provided in the center-near optical zone 312 between +0.9 and +1.1 diopters. As shown in an example in FIG. 15B, the mid-add power profile 1502 for a mid-add power center-near non-dominant eye includes a center-near optical zone 312 with a center-far zone diameter of 4.0 mm, a transitional optical zone 314 having a transitional diameter between 4.0 and 6.0 mm, and add power provided in the center-far optical zone between +0.9 and +1.2 diopters. As shown in the example in FIG. 15C, the high-add power profile 1504 for a high-add power center-near non-dominant eye lens includes a center-near optical zone 312 with a center-far zone diameter of 4.0 mm, a transitional optical zone 314 having a transitional diameter between +4.0 and +6.0 mm, and add power provided in the center-near optical zone 312 of between +1.0 and +1.2 diopters.

As shown in the example in FIG. 15D, the low-add power profile 1506 for a low-add power center-far dominant eye includes a center-far optical zone 306 with a center-far zone diameter of between 2.0 and 2.8 mm, a transitional optical zone 308 having a transitional zone greater than the center-far zone diameter, and add power provided in the center-far optical zone between +0.1 and +0.4 diopters. As shown in an example in FIG. 15E, the mid-add power profile 1508 for a mid-add power center-far dominant eye includes a center-far optical zone 306 with a center-far zone diameter between 2.2 and 2.8 mm, a transitional optical zone 308 having a transitional radius greater than the center-far zone diameter, and add power provided in the center-far optical zone 306 between +0.1 and +0.4 diopters. As shown in the example in FIG. 15F, the high-add power profile 1510 of a high-add power center-far dominant eye lens may be designed to have mid-add power profile that includes a center-far optical zone 306 with a center-far zone diameter between 1.8 and 2.2 mm, a transitional optical zone 308 having a transitional radius greater than 2.0 mm, and add power provided in the center-far optical zone between +0.1 and +0.4 diopters.

An enhanced-summation contact lens pair system that includes a pair of center-near non-dominant eye and center-far dominant eye lenses, and as described above, can include labeled add powers that are in the range and/or include +0.75 diopters to +2.5 diopters, including endpoints. This is so that a variety of different accommodation add powers can be provided as options for wearers.

As an example, as shown in the power profiles 1500-1510 in FIGS. 15A-15D, the powers in the respective transitional optical zones 314, 308 at any given radius from a center axis for complementary pairs of low-add power lenses (FIGS. 15A and 15D), mid-add power lenses (FIGS. 15B and 15E), and high-add power lenses (FIGS. 15C and 15F) differs by less than 1.4 diopters. For example, the powers in the respective transitional optical zones 314, 308 at a radius of 3.0 mm from a center axis for complementary pairs of low-add power lenses (FIGS. 15A and 15D), mid-add power lenses (FIGS. 15B and 15E), and high-add power lenses (FIGS. 15C and 15F) can differ by less than 1.0 diopter. This is to minimize the disparity in refractive correction power at intermediate and far distances while also providing enhanced binocular vision through EDOF of the lens pairs. In another example, the powers in the respective transitional optical zones 314, 308 at any given radius from a center axis for complementary pairs of low-add power lenses (FIGS. 15A and 15D), mid-add power lenses (FIGS. 15B and 15E), and high-add power lenses (FIGS. 15C and 15F) differs by less than 1.3 diopters. In another example, the powers in the respective transitional optical zones 314, 308 at any given radius from a center axis for complementary pairs of low-add power lenses (FIGS. 15A and 15D), mid-add power lenses (FIGS. 15B and 15E), and high-add power lenses (FIGS. 15C and 15F) differs by less than 1.2 diopters. In another example, the powers in the respective transitional optical zones 314, 308 at any given radius from a center axis for complementary pairs of low-add power lenses (FIGS. 15A and 15D), mid-add power lenses (FIGS. 15B and 15E), and high-add power lenses (FIGS. 15C and 15F) differs by less than 1.1 diopters. In another example, the powers in the respective transitional optical zones 314, 308 at any given radius from a center axis for complementary pairs of low-add power lenses (FIGS. 15A and 15D), mid-add power lenses (FIGS. 15B and 15E), and high-add power lenses (FIGS. 15C and 15F) differs by less than 1.0 diopters.

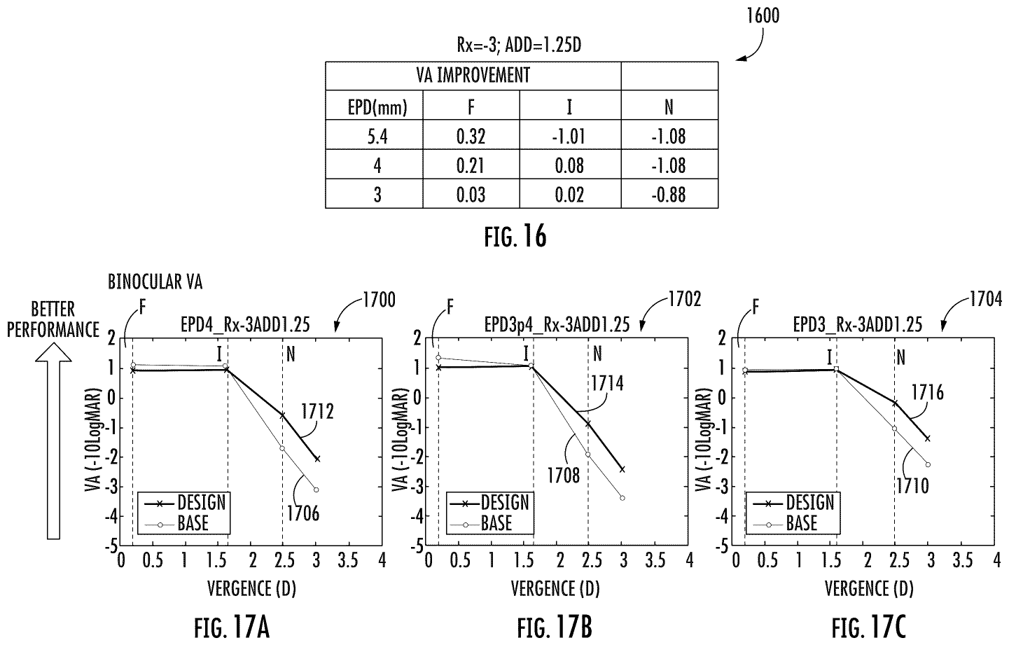

Additional studies were performed to model VA of enhanced-summation contact lens pairs, like the enhanced-summation contact lens pair 300 in FIG. 3, for different assumptions of pupil diameters when focused on near-distance objects to further verify the results and designs of the lenses described above. For example, as shown in the chart 1600 in FIG. 16, binocular VA improvement was determined for enhanced-summation contact lens pairs that included a center-near non-dominant eye lens with a center-near zone diameter of a center-near optical zone for effective pupil diameters (EPD) of 5.4 mm, 4 mm, and 3 mm of an enhanced-summation contact lens pair, like in

FIG. 3 for example, as worn by a patient having an exemplary correction prescription of −3.0 diopters for a myope with an effective add power of +1.25 diopters. The binocular VA improvements shown in chart 1600 in FIG. 16 are as compared to the patient wearing a comparable 1-day Acuvue® moist presbyopia contact lens pair which has a center-near optical zone for both dominant and non-dominant eyes. The improvement was determined for far-distance vision (F), intermediate-distance vision (I), and near-distance vision (N), as shown in chart 1600.

A negative value in chart 1600 in FIG. 16 means that the enhanced-summation contact lens pair has a better VA performance than that of the 1-day Acuvue® moist presbyopia contact lens pair. ‘F,’ ‘I,’ and ‘N’ mean far-distance, intermediate-distance, and near-distance vision, respectively. A positive value in chart 1600 in FIG. 16 means that the enhanced-summation contact lens pair has a lesser VA performance than that of the 1-day Acuvue® moist presbyopia contact lens pair. The results are given with a unit of −10 LogMAR, wherein ‘1’ means 1-line variation. As an example, as shown in FIG. 16, with 4-mm pupil, the VA performance of the enhanced-summation contact lens pair is -1.08 better than the 1-day Acuvue® moist presbyopia contact lens pair at near-distance vision, which means the enhanced-summation contact lens pair is more than 1-line better in VA than that of the 1-day Acuvue® moist presbyopia contact lens pair.

FIGS. 17A-17C are graphs 1700, 1702, 1704 illustrating exemplary VA (Y-axis) as a function of vergence (X-axis) for enhanced-summation contact lens pairs that were used to determine the VA improvements shown in the chart 1600 in FIG. 16. The graphs 1700, 1702, 1704 are based on determining VA for an enhanced-summation contact lens pair that includes a center-far dominant eye lens and center-near non-dominant eye lens with a center-near zone diameter of a center-near optical zone for respective effective pupil diameters (EPD) of 5.4 mm, 4 mm, and 3 mm as compared to a comparable 1-day Acuvue® moist presbyopia contact lens pair which has a center-near optical zone for both dominant and non-dominant eyes for an exemplary correction prescription of −3.0 diopters for a myope with an add power of +1.25 diopters. Curves 1706, 1708, 1710 in FIGS. 17A-17C illustrate the VA of the 1-day Acuvue® moist presbyopia contact lens pair for a center-near zone diameter of a center-near optical zone for respective effective pupil diameters (EPD) of 5.4 mm, 4 mm, and 3 mm. Curves 1712, 1714, 1716 in FIGS. 17A-17C illustrate the VA of the 1-day Acuvue® moist presbyopia contact lens pair for a center-near zone diameter of a center-near optical zone for respective effective pupil diameters (EPD) of 5.4 mm, 4 mm, and 3 mm. As shown in FIGS. 17A-17C, the enhanced-summation contact lens pair with a center-far dominant eye lens and center-near non-dominant eye lens with a center-near zone diameter of a center-near optical zone have an improved VA over the 1-day Acuvue® moist presbyopia contact lens pair for intermediate-distance and near-distance vision without any or almost no compromise in VA for far-distance vision.

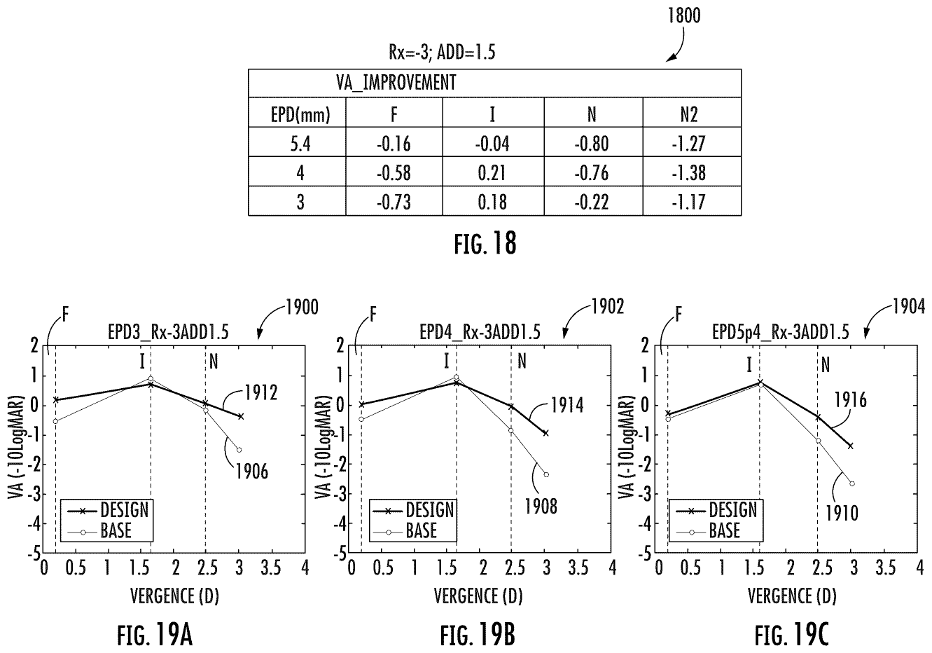

The results of another VA improvement study are shown in the chart 1800 in FIG. 18, VA improvement was determined for enhanced-summation contact lens pairs that included a center-near non-dominant eye lens with a center-near zone diameter of a center-near optical zone for effective pupil diameters (EPD) of 5.4 mm, 4 mm, and 3 mm of an enhanced-summation contact lens pair like in FIG. 3 for an exemplary correction prescription of −3.0 diopters for a myope with an add power of +1.5 diopters. The VA improvements shown in chart 1800 in FIG. 18 are as compared to 1-day Acuvue® moist presbyopia contact lens pair, which has a center-near optical zone for both dominant and non-dominant eyes. The improvement was determined for far-distance vision (F), intermediate-distance vision (I), and near-distance vision (N), as shown in chart 1800.

FIGS. 19A-19C are graphs 1900, 1902, 1904 illustrating exemplary VA (Y-axis) as a function of vergence (X-axis) for enhanced-summation contact lens pairs that were used to determine the binocular VA improvements shown in the chart 1800 in FIG. 18. The graphs 1900, 1902, 1904 are based on determining VA for a patient wearing an enhanced-summation contact lens pair, like in FIG. 3, that includes a center-far dominant eye lens and center-near non-dominant eye lens with a center-near zone diameter of a center-near optical zone for respective effective pupil diameters (EPD) of 5.4 mm, 4 mm, and 3 mm as compared to the patient wearing a comparable 1-day Acuvue® moist presbyopia contact lens pair which has a center-near optical zone for both dominant and non-dominant eyes for an exemplary correction prescription of −3.0 diopters for a myope with an add power of +1.5 diopters. A negative value in chart 1800 in FIG. 18 means that the enhanced-summation contact lens pair has a better VA performance than that of the 1-day Acuvue® moist presbyopia contact lens pair. A positive value in chart 1800 in FIG. 18 means that the enhanced-summation contact lens pair has a lesser VA performance than that of the 1-day Acuvue® moist presbyopia contact lens pair. ‘F,’ ‘I,’ and ‘N’ mean far-distance, intermediate-distance, and near-distance vision, respectively.

Curves 1906, 1908, 1910 in FIGS. 19A-19C illustrate the VA of the 1-day Acuvue® moist presbyopia contact lens pair for a center-near zone diameter of a center-near optical zone for respective effective pupil diameters (EPD) of 5.4 mm, 4 mm, and 3 mm. Curves 1912, 1914, 1916 in FIGS. 19A-19C illustrate the VA of the 1-day Acuvue® moist presbyopia contact lens pair for a center-near zone diameter of a center-near optical zone for respective effective pupil diameters (EPD) of 5.4 mm, 4 mm, and 3 mm. As shown in FIGS. 19A-19C, the enhanced-summation contact lens pair with a center-far dominant eye lens and center-near non-dominant eye lens with a center-near zone diameter of a center-near optical zone have an improved VA over the 1-day Acuvue® moist presbyopia contact lens pair for intermediate-distance and near-distance vision without any or almost no compromise in VA for far-distance vision. As an example, as shown in FIG. 18, with a 4 mm pupil, the VA performance of the enhanced-summation contact lens pair is −1.38 better (or more than 1-line better) than the 1-day Acuvue® moist presbyopia contact lens pair at near-distance vision.

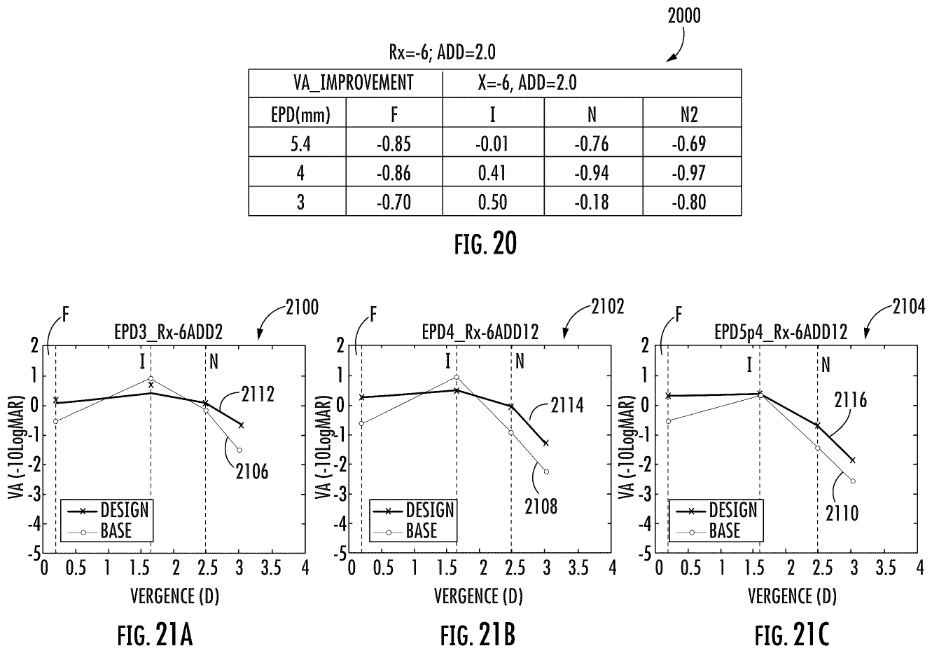

The results of another VA improvement study are shown in the chart 2000 in FIG. 20, VA improvement was determined for enhanced-summation contact lens pairs that included a center-near non-dominant eye lens with a center-near zone diameter of a center-near optical zone for effective pupil diameters (EPD) of 5.4 mm, 4 mm, and 3 mm of an enhanced-summation contact lens pair like in FIG. 3 for an exemplary correction prescription of −6.0 diopters for a myope with an add power of +2.0 diopters. The VA improvements shown in chart 2000 in FIG. 20 were as compared to 1-day Acuvue® moist presbyopia contact lens pair, which has a center-near optical zone for both dominant and non-dominant eyes. The improvement was determined for far-distance vision (F), intermediate-distance vision (I), and near-distance vision (N), as shown in chart 2000.

FIGS. 21A-21C are graphs 2100, 2102, 2104 illustrating exemplary VA (Y-axis) as a function of vergence (X-axis) for enhanced-summation contact lens pairs that were used to determine the binocular VA improvements shown in the chart 2000 in FIG. 20. The graphs 2100, 2102, 2104 are based on determining VA for a patient wearing an enhanced-summation contact lens pair, like in FIG. 3, that includes a center-far dominant eye lens and center-near non-dominant eye lens with a center-near zone diameter of a center-near optical zone for respective effective pupil diameters (EPD) of 5.4 mm, 4 mm, and 3 mm as compared to the patient wearing a comparable 1-day Acuvue® moist presbyopia contact lens pair which has a center-near optical zone for both dominant and non-dominant eyes for an exemplary correction prescription of −6.0 diopters for a myope with an add power of +2.0 diopters. A negative value in the chart 2000 in FIG. 20 means that the enhanced-summation contact lens pair has a better VA performance than that of the 1-day Acuvue® moist presbyopia contact lens pair. A positive value in chart 2000 in FIG. 20 means that the enhanced-summation contact lens pair has a lesser VA performance than that of the 1-day Acuvue® moist presbyopia contact lens pair. ‘F,’ ‘I,’ and ‘N’ mean far-distance, intermediate-distance, and near-distance vision, respectively.

Curves 2106, 2108, 2110 in FIGS. 21A-21C illustrate the VA of the 1-day Acuvue® moist presbyopia contact lens pair for a center-near zone diameter of a center-near optical zone for respective effective pupil diameters (EPD) of 5.4 mm, 4 mm, and 3 mm. Curves 2112, 2114, 2116 in FIGS. 21A-21C illustrate the VA of the 1-day Acuvue® moist presbyopia contact lens pair for a center-near zone diameter of a center-near optical zone for respective effective pupil diameters (EPD) of 5.4 mm, 4 mm, and 3 mm. As shown in FIGS. 21A-21C, the enhanced-summation contact lens pair with a center-far dominant eye lens and center-near non-dominant eye lens with a center-near zone diameter of a center-near optical zone have an improved VA over the 1-day Acuvue® moist presbyopia contact lens pair for intermediate-distance and near-distance vision without any or almost no compromise in VA for far-distance vision. As an example, as shown in FIG. 20, with a 4 mm pupil, the VA performance of the enhanced-summation contact lens pair is −0.97 better (or almost 1-line better) than the 1-day Acuvue® moist presbyopia contact lens pair at near-distance vision.

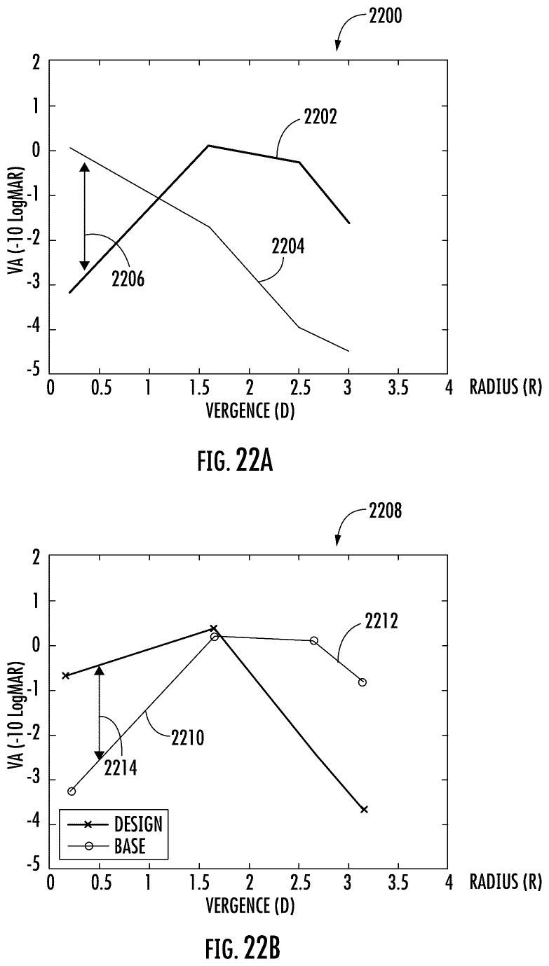

It is also desired to provide a fitting procedure and guide for fitting a contact lens wearer with lenses for their dominant and non-dominant eyes using the enhanced-summation contact lens pairs based on the design of enhanced-summation contact lens pair 300 in FIG. 3. The enhanced-summation contact lens pairs can be selected from enhanced-summation contact lens pairs in an enhanced-summation contact lens pair system like shown in FIGS. 15A-15F, based on a low, mid, and high-add powers for correction of presbyopia as well as the correction prescription for the wearer's eyes. Because of the design differences between the center-far dominant eye lenses and the center-near non-dominant eye lenses in the enhanced-summation contact lens pair, there may be a VA disparity in far-distance vision between the dominant eye and the non-dominant eye experienced by the wearer. This is shown in the graph 2200 in FIGS. 22A. The graph 2200 in FIG. 22A illustrates VA (Y-axis) as a function of vergence (X-axis) according to the enhanced-summation contact lens pair designs described herein. Curve 2202 in FIG. 22A illustrates VA as a function of vergence for a non-dominant eye fitted with a center-near lens according to the enhanced-summation contact lens pair designs described herein. As shown in FIG. 22A, there can be a larger VA disparity 2206 between the non-dominant eye and the dominant eye of a lens wearer fitted with respective center-near and center-far lenses according to the enhanced-summation contact lens pair designs described herein. However, by fitting the dominant and non-dominant eye with a respective center-far and/or center-near lens power with variations in refractive correction power (or lens label power) that deviate from the patient's prescription refractive correction, this VA disparity at far-distance vision may be able to be reduced as shown in the graph 2208 in FIG. 22B.

In this regard, curve 2210 in FIG. 22B illustrates VA (Y-axis) as a function of vergence (X-axis) for a non-dominant eye fitted with a center-near lens according to the enhanced-summation contact lens pair designs described herein. Curve 2212 in FIG. 22B illustrates VA as a function of vergence for a dominant eye fitted with a center-far lens according to the enhanced-summation contact lens pair designs described herein. The VA disparity 2214 between the dominant and non-dominant eye with a respective center-far and/or center-near lens is less than the VA disparity 2206 in the graph 2200 in FIG. 22A. Further, the equivalent spherical power employed in the respective center-far and center-near lenses for a dominant and non-dominant eye can also be further reduced. The VA difference (and/or equivalent sphere power variation from prescription power difference) between a dominant eye and non-dominant eye is a criteria for binocular disparity. With reduced disparity, the enhanced-summation contact lens pairs described herein are expected to maintain similar far-distance vision performance and near-distance vision advantages (compare a control lens, such as the 1-day Acuvue® moist presbyopia contact lens pair previously discussed above).

FIGS. 23A-23F are graphs 2300A-2300F illustrating a fitting guide for a contact lens wearer wearing dominant eye, center-far and non-dominant eye, center-near lenses like in FIG. 3, from an enhanced-summation contact lens pair system like described in FIGS. 15A-15F as an example. The graphs 2300A-2300F illustrate exemplary respective VAs (Y-axis) 2302A-2302F, 2304A-2304F as a function of vergence (X-axis) for contact lens wearer wearing respective center-far dominant eye lens and center-near non-dominant eye lenses like in FIG. 3. Each graph 2300A-2300F shows a fitting step in an increment of fitting steps in an attempt to provide a reduced disparity in VA to the wearer. The fitting guide in FIGS. 23A-23F is described in conjunction with an exemplary fitting guide process 2400 in FIG. 24.

For example, as shown in graph 2300A in FIG. 23A, a first step in a fitting process 2400 shown in FIG. 24 of fitting a patient with an enhanced-summation contact lens pair as described herein is to select patient's add power for the contact lens wearer (block 2402 in FIG. 24). The add powers for the selected center-near lenses may be selected from the low, mid, and high-add powers described in FIGS. 15A-15F and based on the age of the wearer (block 2402 in FIG. 24). A next step in the fitting process 2400 is select a patient's initial center-near non-dominant eye lens and a center-far dominant eye lens based on lens' labeled powers, according to patient's respective eye prescriptions and the desired add power (block 2404 in FIG. 24). For example, this process includes selecting a center-near lens among a plurality of center-near lenses in an enhanced-summation contact lens pair system, like in FIGS. 15A-15F for the wearer's non-dominant eye based on their corrective prescription selected to substantially correct distance vision in their non-dominant eye (block 2406 in FIG. 24). For example, the refractive corrections used to select the contact lenses in steps 2404 and 2406 may be determined on the patient's need for refractive correction when focusing on a far-distance object at 0.25 diopters. Then, this process includes selecting a center-far lens among a plurality of center-far lenses in an enhanced-summation contact lens pair system, like in FIGS. 15A-15F for the wearer's dominant eye based on their corrective prescription selected to substantially correct distance vision in their dominant eye (block 2408 in FIG. 24).

Next, the patient wearer can provide feedback to the fitting technician or physician based on their perceived stereopsis based on the far-distance vision acuity difference between the wearer's dominant eye fitted with the current selected center-far lens and the wearer's non-dominant eye fitted with the current selected center-near lens (block 2410 in FIG. 24). This perceived stereopsis based on the far-distance vision acuity difference is a subjective measurement by the wearer based on whether their brain can effectively provide summation of light received by their eyes fitted with the current selected center-far lens and the wearer's non-dominant eye fitted with the current selected center-near lens. If the feedback from the wearer indicates a reduced stereopsis based on the far-distance vision acuity difference between the wearer's dominant eye fitted with the current selected center-far lens and the wearer's non-dominant eye fitted with the current selected center-near lens (block 2412 in FIG. 24), the patient can be fitted with a next different combination of center-near and center-far lenses to try to reduce the far-distance vision acuity difference to their perception.

In this regard, as shown in the exemplary graph 2300B in FIG. 23B, a next step in the fitting process may be to select a next center-far dominant eye lens that has an increased correction power (e.g., +0.5 diopters), for example while leaving the center-near non-dominant eye lens the same (block 2414 in FIG. 24). As shown in the graph 2300B in FIG. 23B, this may have the effect of reducing the VA disparity at far-distance vision. If the feedback from the wearer still indicates a reduced stereopsis based on the far-distance vision acuity difference between the wearer's dominant eye fitted with the current selected center-far lens and the wearer's non-dominant eye fitted with the current selected center-near lens (block 2412 in FIG. 24), a next step may be to then select a next center-near non-dominant eye lens with a reduced refractive correction power (e.g., −0.25 diopters) while leaving the center-far dominant eye lens the same as shown in the example graph 2300C in FIG. 23C (block 2416 in FIG. 24). As shown in the graph 2300C in FIG. 23C, this may have the effect of reducing the VA disparity at far-distance vision to an acceptable level to the wearer.

Again, if the feedback from the wearer still indicates a reduced stereopsis based on the far-distance vision acuity difference between the wearer's dominant eye fitted with the current selected center-far lens and the wearer's non-dominant eye fitted with the current selected center-near lens (block 2412 in FIG. 24), a next step may be to then select a next center-near non-dominant eye lens with a further decrease in refractive correction power (e.g., −0.5 diopters) while leaving the center-far non-dominant eye lens the same as shown in the example graph 2300D in FIG. 23D (block 2414 in FIG. 24). As shown in the graph 2300D in FIG. 23D, this may have the effect of reducing the VA disparity at far-distance vision to an acceptable level to the wearer. If the feedback from the wearer still indicates a reduced stereopsis based on the far-distance vision acuity difference between the wearer's dominant eye fitted with the current selected center-far lens and the wearer's non-dominant eye fitted with the current selected center-near lens (block 2412 in FIG. 24), a next step may be to then select a next center-far dominant eye lens with a further increased refractive correction power (e.g., +0.75 diopters) and also selecting a next center-near non-dominant eye lens with a decreased refractive correction power (e.g., −0.25 diopter), as shown in the example graph 2300E in FIG. 23E (block 2414 in FIG. 24). As shown in the graph 2300E in FIG. 23E, this may have the effect of reducing the VA disparity at far-distance vision to an acceptable level to the wearer. Again, if the feedback from the wearer still indicates a reduced stereopsis based on the far-distance vision acuity difference between the wearer's dominant eye fitted with the current selected center-far lens and the wearer's non-dominant eye fitted with the current selected center-near lens (block 2412 in FIG. 24), a next step may be to then select both a next center-near non-dominant eye lens with a further decrease in refractive correction power (e.g., −0.5 diopters) (block 2414 in FIG. 24) while leaving the center-far dominant eye lens the same the same (block 2416 in FIG. 24) as shown in the example graph 2300F in FIG. 23F. As shown in the graph 2300F in FIG. 23F, this may have the effect of reducing the VA disparity at far-distance vision to an acceptable level to the wearer. As shown in graph 2300F in FIG. 23F, the total difference in increase in diopter in the center-far dominant eye lens and the decrease in diopter in the center-near non-dominant eye lens is the same (1.0 diopter) as in the graph 2300E in FIG. 23E. However, this may still have the effect of reducing the VA disparity at far-distance vision to an acceptable level to the wearer.

Note that the aspects described above are in regard to exemplary contact lens pairs, but not that such examples are not limited to contact lenses but could be applied to any type of lenses and related lens pairs.

It is important to note that the lens designs of the present disclosure may be incorporated into any number of different contact lenses formed from any number of materials. Specifically, the lens design of the present disclosure may be utilized in any of the contact lenses described herein, including, but not limited to, daily wear soft contact lenses, rigid gas permeable contact lenses, bifocal contact lenses, toric contact lenses, and hybrid contact lenses. In addition, although the disclosure is described with respect to contact lenses, it is important to note that the concept of the present disclosure may be utilized in spectacle lenses, intraocular lenses, corneal inlays, and onlays.

It is to be understood that the disclosure is not to be limited to the specific aspects disclosed and that modifications and other aspects are intended to be included within the scope of the appended claims and their equivalents. Although specific terms are employed herein, they are used in a generic and descriptive sense only and not for purposes of limitation. Upon reading the following description in light of the accompanying drawing figures, those skilled in the art will understand the concepts of the disclosure and will recognize applications of these concepts not particularly addressed herein. The aspects set forth below represent the necessary information to enable those skilled in the art to practice the disclosure and illustrate the best mode of practicing the disclosure. It should be understood that these concepts and applications fall within the scope of the disclosure and the accompanying claims. Many modifications and other embodiments of the disclosure set forth herein will come to mind to one skilled in the art to which the disclosure pertains, having the benefit of the teachings presented in the foregoing descriptions and the associated drawings. Although shown and described in what is believed to be the most practical and specific aspects disclosed, modifications and other aspects are intended to be included within the scope of the appended claims. It is apparent that departures from specific designs and methods described and shown will suggest themselves to those skilled in the art and may be used without departing from the spirit and scope of the disclosure.

What is claimed is:

1. A contact lens pair, comprising:
a center-far lens for a dominant eye of a contact lens wearer, comprising:
a center-far optical zone of a center-far zone diameter disposed around a first optical axis and having a first power selected to substantially correct distance vision in the dominant eye; and
a first transitional optical zone surrounding the first center optical zone, the first transitional optical zone having a first progressive power profile; and
a center-near lens for a non-dominant eye of the contact lens wearer, comprising:
a center-near optical zone of a center-near zone diameter surrounding a second optical axis and having a second power selected to substantially correct distance vision in the non-dominant eye and add power of at least +0.75 diopters relative to the first power; and
a second transitional optical zone surrounding the second center optical zone, the second transitional optical zone having a second progressive power profile;
wherein the center-far zone diameter and the center-near zone diameter are selected such that when the contact lens wearer is focusing on a near-distance object, a contact lens pair comprising the center-far lens and the center-near lens emulates monovision, and when the contact lens wearer is focusing on a far-distance object, the contact lens pair emulates partial monovision; and
wherein the first transitional optical zone and the second transitional optical zone are selected such that when the contact lens wearer is focusing on an intermediate-distance object, the contact lens pair emulates an extended depth of focus lens through binocular summation.

2. The contact lens pair of claim 1, wherein the center-far zone diameter is between 1.8 millimeters (mm) and 3.8 mm.

3. The contact lens pair of claim 1, wherein the center-near zone diameter is between 2.6 millimeters (mm) and 4.0 mm.

4. The contact lens pair of claim 1, wherein the center-far optical zone has a spherical aberration (SPHA) dependent on the first power (Rx) as follows:
$$a . if Rx \leq - 3 diopters , then S P H A = 0.0082 * Rx - 0.0251 ;$$
$$and$$
$$b . if Rx > - 3 diopters , then S P H A = - 0.0497 .$$

5. The contact lens pair of claim 1, wherein the first progressive power profile and the second progressive power profiles at any radius from their respective first optical axis and second optical axis differ by less than 1.4 diopters; by less than 1.3 diopters; by less than 1.2 diopters; by less than 1.1 diopters; or by less than 1.0 diopters.

6. The contact lens pair of claim 1, wherein:
the first progressive power profile comprises a first continuous power profile; and
the second progressive power profile comprises a second continuous power profile.

7. The contact lens pair of claim 1, wherein the second power profile comprises a derivative power profile.

8. The contact lens pair of claim 1, wherein the center-far lens has a power profile comprised from the group consisting of:
a dominant low-add power profile comprising a center-far zone diameter between 2.0 and 2.8 mm, the first transitional optical zone having a first transitional radius greater than the center-far zone diameter, and a dominant add power provided in the center-far zone increasing radially from 0 at lens center to between +0.1 and +0.4 diopters;
a dominant mid-add power profile comprising a center-far zone diameter between 2.4 and 3.8 mm the first transitional optical zone having a first transitional radius greater than the center-far zone diameter, and a dominant add power provided in the center-far zone increasing radially from 0 at lens center to between +0.1 and +0.4 diopters, and
a dominant high-add power profile comprising a center-far zone diameter between 1.8 and 2.2 mm, the first transitional optical zone having a first transitional radius greater than 2.0 mm, and a dominant add power provided in the center-far zone increasing radially from 0 at lens center to between +0.1 and +0.4 diopters.

9. The contact lens pair of claim 8, wherein the center-near lens has a power profile comprised from the group consisting of or substantially of:
a non-dominant low-add power profile comprising the center-near zone diameter of 4.0 mm, the second transitional optical zone having a second transitional diameter between 4.0 mm to 6.0 mm, and the add power between +0.9 and +1.1 diopters;
a non-dominant mid-add power profile comprising the center-near diameter of 4.0 mm, the second transitional optical zone having a second transitional diameter between 4.0 mm to 6.0 mm, and the add power between +0.9 and +1.2 diopters; and
a non-dominant high-add power profile comprising the center-near diameter of 4.0 mm, the second transitional optical zone having a second transitional diameter between +4.0 mm to +6.0 mm, and the add power of between +1.0 and +1.2 diopters.

10. The contact lens pair of claim 9, wherein the first transitional optical zone of the center-far lens and the second transitional optical zone of the center-near lens, at any radial distance from the respective first and second optical axis differ by less than 1.4 diopters, less than 1.3 diopters, less than 1.2 diopters, less than 1.1 diopters or less than 1.0 diopters.

11. The contact lens pair of claim 1, wherein:
at least 65% of the add power is within two (2) millimeter (mm) radius of the second optical axis in the center-near optical zone; and
the remaining add power of the add power outside of the two (2) mm radius of the second optical axis.

12. The contact lens pair of claim 1 having a greater visual acuity (VA) for vision focused on the near-distance object with degrading vision focused on the intermediate-distance object or the far-distance object, as compared to a 1-day Acuvue® moist presbyopia contact lens pair which has a center-near extended depth of focus design (EDOF) for both dominant and non-dominant eye.

13. The contact lens pair of claim 12 having at least a 0.8 visual acuity (VA) improvement for vision focused on the near-distance object, as compared to a 1-day Acuvue® moist presbyopia contact lens pair.

14. The contact lens pair of claim 1, wherein the add power provides an effective add power less than +2.0 diopters.

15. The contact lens pair of claim 1, wherein the second power is for hyperopia correction.

16. The 1 contact lens pair of claim 1, wherein the center-near zone diameter is targeted to an average pupil size of a population.

17. The contact lens pair of claim 16, wherein population is one (1).

18. A contact lens pair, comprising:
a center-far lens for a dominant eye of a contact lens wearer, comprising:
a center-far optical zone of a center-far zone diameter disposed around a first optical axis and having a first power selected to substantially correct distance vision in the dominant eye; and
a first transitional optical zone surrounding the first center optical zone, the first transitional optical zone having a first progressive power profile; and
a center-near lens for a non-dominant eye of the contact lens wearer, comprising:
a center-near optical zone of a center-near zone diameter targeted to an average pupil size of a population, and surrounding a second optical axis and having a second power selected to substantially correct distance vision in the non-dominant eye and an add power relative to the first power; and
a second transitional optical zone surrounding the second center optical zone, the second transitional optical zone having a second progressive power profile.

19. The contact lens pair of claim 18, wherein the center-far zone diameter is between 1.8 millimeters (mm) and 3.8 mm.

20. The contact lens pair of claim 18, wherein the center-near zone diameter is between 2.6 millimeters (mm) and 4.0 mm.

21. The contact lens pair of claim 18, wherein the center-far optical zone has a spherical aberration (SPHA) dependent on the first power (Rx) as follows:
$$a . if Rx \leq - 3 diopters , then S P H A = 0.0082 * Rx - 0.0251 ;$$
$$and$$
$$b . if Rx > - 3 diopters , then S P H A = - 0.0497 .$$

22. The contact lens pair of claim 18, wherein the first progressive power profile and the second progressive power profiles at any radius from their respective first optical axis and second optical axis differ by less than 1.4 diopters; by less than 1.3 diopters; by less than 1.2 diopters; by less than 1.1 diopters; or by less than 1.0 diopters.

23. The contact lens pair of claim 18, wherein:
the first progressive power profile comprises a first continuous power profile; and
the second progressive power profile comprises a second continuous power profile.

24. The contact lens pair of claim 18, wherein the second progressive power profile comprises a derivative continuous power profile.

25. The contact lens pair of any of claim 18 having a greater visual acuity (VA) for vision focused on the near-distance object with degrading vision focused on the intermediate-distance object or the far-distance object, as compared to a 1-day Acuvue® moist presbyopia contact lens pair which has a center-near extended depth of focus design (EDOF) for both dominant and non-dominant eye.

26. A contact lens pair system, comprising:
a plurality of center-far lenses for a dominant eye of a contact lens wearer, each comprising:
a center-far optical zone of a center-far zone diameter disposed around a first optical axis and having a first power selected to substantially correct distance vision in the dominant eye; and
a first transitional optical zone surrounding the first center optical zone, the first transitional optical zone having a first progressive power profile; and
a plurality of center-near lenses for a non-dominant eye of a contact lens wearer, each comprising:
a center-near optical zone of a center-near zone diameter surrounding a second optical axis and having a second power selected to substantially correct distance vision in the non-dominant eye, an add power of at least +0.75 diopters relative to the first power; and
a second transitional optical zone surrounding the second center optical zone, the second transitional optical zone having a second progressive power profile;
wherein the center-far zone diameter and the center-near zone diameter for a contact lens pair comprising a center-far lens of the plurality of center-far lenses and a center-near lens of the plurality of center-near lenses, are selected such that when the contact lens wearer is looking at a near-distance object, the contact lens pair emulates monovision, and when the contact lens wearer is focusing on a far-distance object, the contact lens pair emulates partial monovision; and
wherein the first transitional optical zone and the second transitional optical zone for the contact lens pair are selected such that when the contact lens wearer is focusing on an intermediate-distance object, the contact lens pair emulates an extended depth of focus lens through binocular summation.

27. The contact lens pair system of claim 26, wherein each center-far zone diameter of the plurality of center-far lenses is between 1.8 millimeters (mm) and 3.8 mm.

28. The contact lens pair system of claim 26, wherein each center-near zone diameter of the plurality of center-nears lenses is between 2.6 millimeters (mm) and 4.0 mm.

29. The contact lens pair system of claim 26, wherein each center-far lens of the plurality of center-far lenses has a power profile comprised from the group consisting of:
a dominant low-add power profile comprising a center-far zone diameter between 2.0 and 2.8 mm, the first transitional optical zone having a first transitional radius greater than the center-far zone diameter, and a dominant add power provided in the center-far zone increasing radially from 0 at lens center to between 0.1 and 0.4 diopters;
a dominant mid-add power profile comprising a center-far zone diameter between 2.4 and 3.8 mm the first transitional optical zone having a first transitional radius greater than the center-far zone diameter, and a dominant add power provided in the center-far zone increasing radially from 0 at lens center to between 0.1 and 0.4 diopters, and
a dominant high-add power profile comprising a center-far zone diameter between 1.8 and 2.2 mm, the first transitional optical zone having a first transitional radius greater than 2.0 mm, and a dominant add power provided in the center-far zone increasing radially from 0 at lens center to between 0.1 and 0.4 diopters.

30. The contact lens pair system of claim 29, wherein each center-near lens of the plurality of center-near lenses has a power profile comprised from the group consisting of:
a non-dominant low-add power profile comprising the center-near zone diameter of 4.0 mm, the second transitional optical zone having a second transitional diameter between 4.0 mm to 6.0 mm, and the add power between +0.9 and +1.1 diopters;
a non-dominant mid-add power profile comprising the center-near diameter of 4.0 mm, the second transitional optical zone having a second transitional diameter between 4.0 mm to 6.0 mm, and the add power between +0.9 and +1.2 diopters; and
a non-dominant high-add power profile comprising the center-near diameter of 4.0 mm, the second transitional optical zone having a second transitional diameter between +4.0 mm to +6.0 mm, and the add power of between +1.0 and 1.2 diopters.

31. The contact lens pair system of claim 26, wherein the add power of the plurality of center-near lenses includes an effective add power in a range of +0.75 diopters to ++1.75 diopters, including endpoints.

32. The contact lens pair system of claim 26, wherein:
the plurality of center-far lenses has a plurality of first power profiles;
the plurality of center-near lenses has a plurality of second power profiles;
the plurality of first power profiles are based on a respective refractive correction between −9.0 diopters and +6.0 diopters including endpoints; and
the plurality of second power profiles are based on a respective refractive correction between −9.0 diopters and +6.0 diopters including endpoints.

33. The contact lens pair system of claim 32, wherein at least one of:
(1) each of the first transitional zones of the plurality of center-far lenses has less than a 1.0 diopter variation from the other first power profiles of the plurality of first power profiles at a given radius from the first optical axis; and
(2) each of the second transitional zones of the plurality of center-near lenses has less than a 1.0 diopter variation from the other second power profiles of the plurality of second power profiles at a given radius from the second optical axis.

34. A method of fitting a contact lens pair of the contact lens pair system of claim 25 to a contact lens wearer, comprising:
a) selecting an add power for the contact lens wearer; and
b) selecting a next contact lens pair for the contact lens wearer, comprising:
a center-near lens of the plurality of center-near lenses having a second power selected to substantially correct distance vision in the contact lens wearer's non-dominant eye and having the add power of the presbyopia correction for the contact lens wearer's non-dominant eye; and
a center-far lens of the plurality of center-far lenses having a first power selected to substantially correct distance vision in the contact lens wearer's dominant eye.

35. The method of claim 34, further comprising:
c) receiving feedback from the contact lens wearer based on a perceived stereopsis based on the far-distance vision acuity difference between the contact lens wearer's dominant eye and non-dominant eye when focusing on a far-distance object; and
d) in response to the feedback indicating a reduced stereopsis based on the far-distance vision acuity difference for the next contact lens pair, perform at least one of:
selecting a next center-far lens of the plurality of center-far lenses for the contact lens wearer having an increase in the next first power; and
selecting a next center-near lens of the plurality of center-near lenses for the contact lens wearer having a decrease in next second power.

36. The method of claim 35, wherein step c) comprises receiving feedback from the contact lens wearer based on the contact lens wearer's perceived visual acuity when looking at the near-distance object based on a disparity in the next center-far lens and the next center-near lens.

37. The method of claim 35, further comprising repeating step d) until the feedback from the contact lens wearer indicates an acceptable perceived stereopsis based on the far-distance vision acuity difference between the contact lens wearer's dominant eye and non-dominant eye when focusing on the far-distance object.

38. The method of claim 34, wherein the increase in next first power is between +0.25 diopters and +0.5 diopters.

39. The method of claim 34, wherein the decrease in next second power is between −0.25 diopters and −0.5 diopters.

40. The method of claim 38, wherein the increase in next first power for each repetition of step d) comprises increments of increases in next first power of +0.5 diopters, +0.5 diopters, +0.5 diopters, +0.75 diopters, and +0.75 diopters.

41. The method of claim 40, wherein the decrease in next second power for each repetition of step d) comprises increments of decreases in next second power of 0 diopters, −0.25 diopters, −0.5 diopters, −0.25 diopters, and −0.5 diopters.

42. The method of claim 38, wherein the decrease in next second power for each repetition of step d) comprises increments of decreases in next second power of 0 diopters, −0.25 diopters, −0.5 diopters, −0.25 diopters, and −0.5 diopters.
